(19) United States
(12) Patent Application Publication
(10) Pub. No.: US 2012/0120677 A1
(43) Pub. Date: May 17, 2012

(54) Backlight Unit and Display Device

(75) Inventors: Hidekazu Miyairi, Atsugi (JP); Kouhei Toyotaka, Atsugi (JP)

(73) Assignee: Semiconductor Energy Laboratory Co., Ltd.

(21) Appl. No.: 13/293,715

(22) Filed: Nov. 10, 2011

(30) Foreign Application Priority Data
Nov. 12, 2010 (JP) 2010-253456

(51) Int. Cl. F21V 8/00; H01J 9/20

(52) U.S. Cl. 362/602; 445/24; 362/616; 362/608; 362/610

(57) ABSTRACT

The novel structure of a backlight unit using color-scan backlight drive which structure can relieve the color mixture problem is provided. A backlight unit including: a light guide plate including (j+1) (j is a natural number) reflective walls that are columns having height in a direction perpendicular to a bottom face and being extended in one direction parallel to the bottom face and that are provided in parallel; an r-th columnar transparent layer provided in a region sandwiched between an r-th (r is a natural number, 1≦r≦j) reflective wall and an (r+1)-th reflective wall of the (j+1) reflective walls; and an r-th light source provided on a side surface of the light guide plate to let light into the r-th transparent layer.

### BACKGROUND OF THE INVENTION

1. Field of the Invention

The present invention relates to a backlight unit. The present invention relates to a display device including the backlight unit. The present invention relates to an electronic device provided with the display device including the backlight unit.

2. Description of the Related Art

Display devices ranging from large display devices such as television receivers to small display devices such as cellular phones have been spreading as represented by liquid crystal display devices. From now on, higher-value-added products will be needed and are being developed. In recent years, attention is attracted to the development of low-power-consumption display devices because interest in global environment is increasing and they may improve the convenience of mobile devices.

Low-power-consumption display devices include display devices displaying images with a field sequential system (also called a color-sequential display system, a time-division display system, or a successive additive color mixture display system). In the field sequential system, the lighting of backlights of red (hereinafter abbreviated to R in some cases), green (hereinafter abbreviated to G in some cases), and blue (hereinafter abbreviated to B in some cases) switches with time, and color images are produced by additive color mixture. Therefore, the field sequential system eliminates the need for a color filter for each pixel and can increase the use efficiency of light from the backlight, thereby achieving low power consumption. In a field-sequential display device, R, G, and B can be expressed with one pixel; therefore, the field-sequential display device is advantageous in that it can easily achieve high-resolution images.

Drive for the field-sequential system has a unique problem of display defect such as color breakup (also referred to as color break). It is known that increasing the frequency of video signal inputs during a certain period can relieve the color breakup problem.

Patent Document 1 and Non-Patent Document 1 each disclose the structure of a field-sequential liquid crystal display device in which a display region is divided into a plurality of regions and a corresponding backlight unit is also divided into a plurality of regions in order to increase the frequency of video signal inputs during a certain period.

### REFERENCE

### Patent Document

Patent Document 1: Japanese Published Patent Application No. 2006-220685

### Non-Patent Document

Non-Patent Document 1: Wen-Chih Tai et al., “Field Sequential Color LCD-TV Using Multi-Area Control Algorithm”, Proc. SID '08 Digest, pp. 1092-1095.

### SUMMARY OF THE INVENTION

In each of the structures disclosed in Patent Document 1 and Non-Patent Document 1, a display region is divided into a plurality of regions and drive for the field sequential system is performed. The backlight unit is also divided into a plurality of regions each corresponding to one of the plurality of regions in the display region, and light are selectively emitted from the respective regions. Here, display defect occurs if not only a corresponding region in the display region but also a region adjacent to the corresponding region are irradiated with light emitted from one region of the backlight unit.

Note that, with display defect, the viewer sees an image into which light of a color different from a predetermined color is mixed; thus display defect is hereinafter called a color mixture problem. In addition, in drive for the field sequential system for which the display region is divided into a plurality of regions and the backlight unit is also divided into a plurality of regions each corresponding to one of the plurality of regions in the display region, a method for driving the backlight unit is called color-scan backlight drive (or scan backlight drive).

The color mixture problem in the case where color-scan backlight drive is performed will be described with reference to schematic views of FIGS. 9A to 9C. FIG. 9A schematically illustrates the structure of a backlight unit. FIG. 9A illustrates a light source portion 901, a light-emitting surface 902, and a diffuser sheet 903 as the components of a backlight unit 900. Note that the light-emitting surface 902 is used to schematically show the scene where light from the light source portion 901 pass through the diffuser sheet 903 and are emitted to a plurality of regions, and the light-emitting surface 902 is actually a surface of the diffuser sheet 903.

Note that although not illustrated in FIG. 9A, a display panel including a display element overlaps with the backlight unit 900. For example, in a liquid crystal display device, a display panel has a region where liquid crystal elements and switching elements controlling whether light from the backlight unit is transmitted or not are arranged in a matrix. The region serves as a display region.

In the light source portion 901 illustrated in FIG. 9A, a plurality of light sources 911 that have a color combination producing white by additive color mixture are arranged in a matrix. The structure in which the light source portion 901 is divided into a first light source region 912, a second light source region 913, and a third light source region 914 in accordance with the division of the display region is illustrated. In the light source portion 901, a red (R) light-emitting diode 915, a green (G) light-emitting diode 916, and a blue (B) light-emitting diode 917 are illustrated as the components of the light source 911 that has a color combination producing white by additive color mixture.

In the light-emitting surface 902 illustrated in FIG. 9A, a first region 921, a second region 922, and a third region 923 are illustrated as regions each corresponding to one of the first light source region 912, the second light source region 913, and the third light source region 914. FIG. 9B illustrates the first region 921, the second region 922, and the third region 923 in the light-emitting surface 902. Each of the rectangular regions has the longitudinal direction 931 and the lateral direction 932.

Suppose, for example, that the second light source region 913 selects the lighting of the green (G) light-emitting diode 916, and the second region 922 emits green light. At this time, the distribution of the intensity of light emitted from the second light source region 913 in FIG. 9A is isotropically spread and is spread by the diffuser sheet 903, so that the second region 922 in the light-emitting surface 902 is formed. Consequently, as schematically illustrated in FIG. 9C, light emitted from the second light source region 913 enters not only the second region 922 but also around the boundaries between the second region 922 and the adjacent first region 921 and between the second region 922 and the adjacent third region 923. Thus, color mixture regions 941 are formed.

Therefore, it is an object of one embodiment of the present invention to provide the novel structure of a backlight unit using color-scan backlight drive which structure can relieve the color mixture problem.

one embodiment of the present invention is a backlight unit including: (j+1) (j is a natural number) reflective walls that are columns having height in a direction perpendicular to a bottom face and being extended in one direction parallel to the bottom face (x direction) and that are provided in parallel; a light guide plate including an r-th columnar transparent layer provided in a region sandwiched between an r-th (r is a natural number, 1≦r≦j) reflective wall and an (r+1)-th reflective wall of the (j+1) reflective walls; and an r-th light source provided on a side surface of the light guide plate to let light into the r-th transparent layer.

The (j+1) reflective walls can be provided at regular intervals.

Note that the light guide plate may further include a reflective layer provided to the bottom face. The reflective layer and the reflective walls may be formed integrally. The reflective layer and the reflective walls may be either of the same material or of different materials. In addition, the backlight unit may further include a reflective sheet. The reflective sheet may be provided to a face of the light guide plate which is opposed to a face through which light is emitted; instead of the reflective layer.

Light generated in the r-th light source is propagated within the r-th transparent layer while being reflected off the adjacent reflective walls or the reflective layer, and then emitted from a surface of the r-th transparent layer. In other words, a surface of the columnar transparent layer corresponds to a part of a light-emitting surface of the backlight unit. Light entering the r-th transparent layer is controlled by the r-th light source. Consequently, in the backlight unit whose light-emitting surface is divided into a plurality of columnar regions, the selection of the luminescent color and emitting state of each region can be made independently. Thus, color scan backlight drive can be made.

Note that a plurality of reflective structures may be provided over a surface of the transparent layer. Controlling the sizes, arrangement, and density of the structures can equalize the intensity distribution of light emitted from the transparent layer.

The backlight unit may further include a diffusion sheet. The backlight unit may further include a prism sheet. The backlight unit may further include a luminance increasing sheet (also called a luminance increasing film). By providing a diffusion sheet, a prism sheet, a luminance increasing sheet, or the like to a face of the light guide plate from which light is emitted, the intensity distribution of light emitted from the light guide plate can be more nearly equalized, and the intensity of light can be increased.

One embodiment of the present invention may be a display device using the above-stated backlight unit.

One embodiment of the present invention can be a display device including a backlight unit and a display panel irradiated with light from the backlight unit. The display panel includes a display region with pixels arranged in a matrix. The display region is divided into a plurality of regions so as to divide one column of the pixels. Image signals are simultaneously input to the pixels in any row in each of the plurality of regions. Note that image signals may be input in sequence to the pixels in any row in each of the plurality of regions. A plurality of columnar transparent layers in the backlight unit is provided to correspond to each of the plurality of regions so that a row direction in the display region (direction in which the pixels in the same row are aligned) and a direction in which columns extend (x direction) may be substantially the same.

Thus, a plurality of rows having pixels to which image signals are input simultaneously (or in sequence) can be irradiated with light of different luminescent colors from the backlight unit. Since a plurality of columnar transparent layers in the backlight unit corresponds to each of the divided regions in the display region, an irradiated region in the divided region irradiated with light can have an approximately columnar shape extended in the row direction and the irradiated region can be scanned in the column direction.

The pixel can include a display element and a switching element. The display element can be a liquid crystal element. The switching element can be a transistor. The transistor may be either one using a semiconductor such as silicon or one using an oxide semiconductor in the active layer.

The reflective walls can reduce light leaking into a region other than a predetermined region, thereby relieving the color mixture problem in the backlight unit using color scan backlight drive. At the same time, light use efficiency can be improved. Further, the number of light sources used in the backlight unit can be reduced, thereby achieving cost reduction.

### BRIEF DESCRIPTION OF THE DRAWINGS

FIGS. 1A to 1D are schematic views illustrating the structure of a backlight unit.

FIGS. 2A to 2E are diagrams illustrating a method for fabricating a light guide plate.

FIGS. 3A to 3F are diagrams illustrating a method for fabricating a light guide plate.

FIGS. 4A to 4C are schematic views illustrating relations between the light guide plate and light sources of the backlight unit.

FIGS. 5A to 5I are schematic views illustrating the arrangement of the light sources of the backlight unit.

FIGS. 6A to 6C are schematic views illustrating light propagation in the backlight unit and the intensity distribution of emitted light.

FIGS. 7A and 7B are schematic views illustrating the cross-sectional structure of a display device including the backlight unit and a display panel.

FIGS. 8A to 8D are diagrams illustrating electronic devices each including the display device.

FIGS. 9A to 9C are schematic views illustrating color mixture problem in color scan backlight drive.

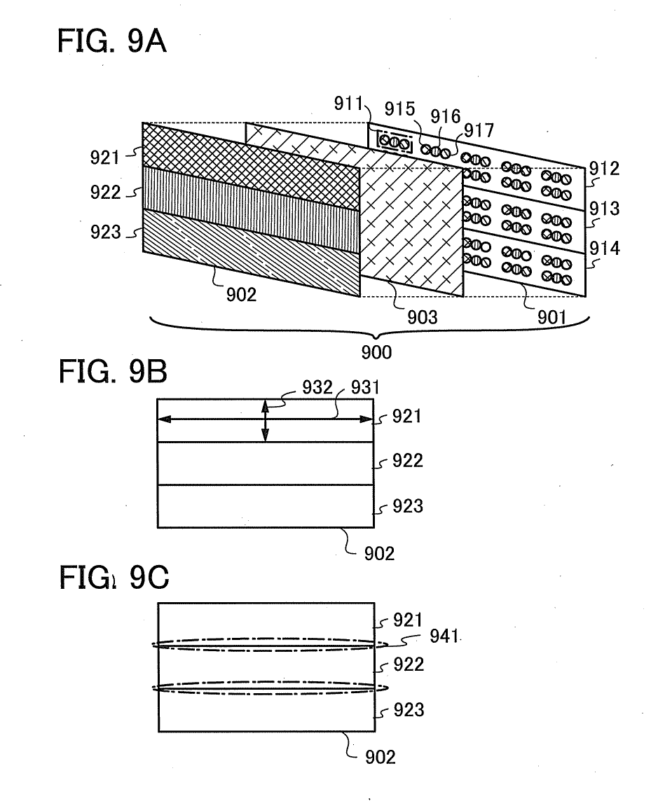

FIG. 10 is a timing diagram illustrating a method for driving the display device using the field sequential system.

FIGS. 11A and 11B are schematic views illustrating correspondences between the pixels and the backlight unit in the display device.

FIGS. 12A to 12E are diagrams illustrating a relation between input of an image signal to each pixel in the display device and the color scan backlight drive.

FIGS. 13A to 13F are diagrams illustrating a relation between input of an image signal to each pixel in the display device and the color scan backlight drive.

FIGS. 14A to 14F are diagrams illustrating a relation between input of an image signal to each pixel in the display device and the color scan backlight drive.

FIGS. 15A1, 15A2, and 15B are top views and a cross-sectional view illustrating the structure of the display panel.

FIGS. 16A to 16C are diagrams illustrating a method for fabricating the light guide plate.

FIG. 17 is a timing diagram illustrating a method for driving the display device using the field sequential system.

FIGS. 18A to 18E are diagrams illustrating a relation between input of an image signal to each pixel in the display device and the color scan backlight drive.

FIGS. 19A to 19F are diagrams illustrating a relation between input of an image signal to each pixel in the display device and the color scan backlight drive.

FIGS. 20A to 20F are diagrams illustrating a relation between input of an image signal to each pixel in the display device and the color scan backlight drive.

FIG. 21 is a timing diagram illustrating a method for driving the display device using the field sequential system.

### DETAILED DESCRIPTION OF THE INVENTION

Embodiments of the present invention will be described below with reference to the drawings. Note that the embodiments can be implemented in various different ways. It will be readily appreciated by those skilled in the art that modes and details of the embodiments can be modified in various ways without departing from the spirit and scope of the present invention. The present invention therefore should not be construed as being limited to the description of the embodiments. Note that in structures of the present invention described below, reference numerals denoting the same portions are used in common in different drawings.

Note that the size, the layer thickness, or the region of each component illustrated in drawings and the like in embodiments is exaggerated for clarity in some cases. Thus, embodiments of the present invention are not limited to such scales.

Note that in this specification, the terms “first”, “second”, “third”, and “n-th” (n is a natural number) are used in order to avoid confusion among components and do not limit the number of components.

### Embodiment 1

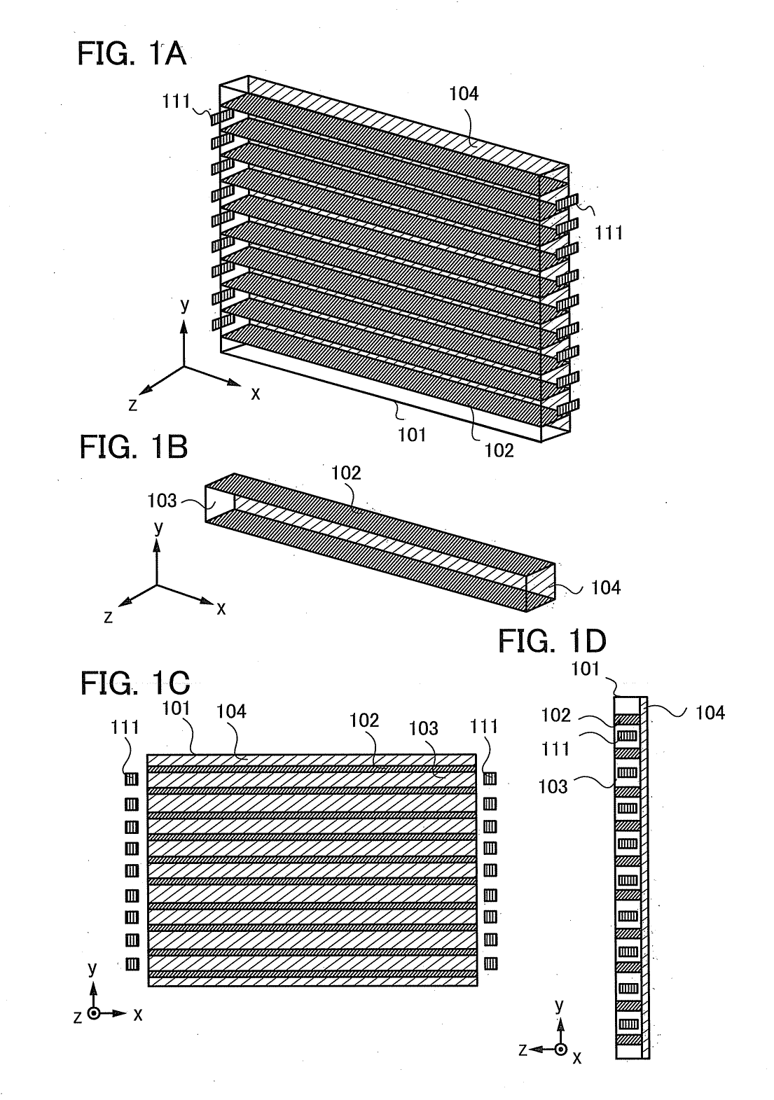

The structure of a backlight unit in one embodiment of the present invention will be described. FIGS. 1A to 1D are schematic views of the backlight unit. FIG. 1A is a perspective view that schematically illustrates the backlight unit. FIG. 1B is a perspective view that schematically illustrates a part of the backlight unit in FIG. 1A. FIG. 1C is a schematic diagram in which the backlight unit shown in FIG. 1A is viewed in the z direction. FIG. 1D is a schematic diagram in which the backlight unit in FIG. 1A is viewed in the x direction. Note that the backlight unit emits light in the z direction.

As illustrated in FIGS. 1A to 1D, the backlight unit includes a light guide plate 101 and light sources 111. The light guide plate 101 includes reflective walls 102, transparent layers 103, and a reflective layer 104.

Each reflective wall 102 is a column that has height in the direction (the z direction in the diagram) perpendicular to a bottom face of the light guide plate 101 (the xy plane in the diagram) and that is extended in one direction parallel to the bottom face (the x direction), and (j+1) (j is a natural number) reflective walls 102 are provided in parallel to each other. Note that FIGS. 1A to 1D illustrate the case where j is 9. The reflective walls 102 can be provided at approximately regular intervals.

The transparent layer 103 is a column and is provided in a region sandwiched between adjacent reflective walls 102. FIGS. 1A to 1D illustrate the structure where nine transparent layers 103 are provided. Note that the transparent layers 103 are present in FIG. 1A although not accompanied by reference numerals. FIG. 1B is a diagram that only illustrates two adjacent reflective walls 102 and the structure of a region sandwiched therebetween to clearly show the transparent layer 103.

The light sources 111 are provided on side surfaces of the light guide plate 101 to let light into the respective transparent layers 103.

The reflective layer 104 is provided on a bottom face of the light guide plate 101 (the xy plane in the diagram).

FIGS. 1A to 1D illustrate the structure in which 10 reflective walls 102 are independent of each other, but one embodiment of the present invention is not limited to this, e.g., any parts of the plurality of reflective walls 102 may be connected to each other. FIGS. 1A to 1D illustrate the structure in which nine transparent layers 103 are independent of each other, but one embodiment of the present invention is not limited to this, e.g., any parts of the plurality of transparent layers 103 may be connected to each other. FIGS. 1A to 1D illustrate the structure in which the light sources 111 are provided to two opposed side surfaces of the light guide plate 101, but one embodiment of the present invention is not limited to this, e.g., the light sources 111 may each be provided to only one of two opposed side surfaces of the light guide plate 101. FIGS. 1A to 1D illustrate the structure in which the reflective layer 104 and the reflective wall 102 are in contact, but one embodiment of the present invention is not limited to this, e.g., there may be a space between the reflective layer 104 and the reflective wall 102. The reflective layer 104 and the reflective walls 102 may be either of different materials or of the same material. In addition, the reflective layer 104 and the reflective walls 102 may be formed integrally. In the backlight unit, a reflective sheet provided to a face which corresponds to the xy plane of the light guide plate 101 and which is opposed to a face through which light is emitted may be a substitute for the reflective layer 104. The reflective walls 102, the reflective layer 104, and the reflective sheet may be formed using reflective paint (e.g., high efficiency reflective paint). Instead of the reflective walls 102, the reflective layer 104, or the reflective sheet, members having a refractive index greatly different from that of the transparent layer 103 may be provided to utilize total reflection produced by a difference between the refractive indexes.

Light generated in the light source 111 is propagated within the transparent layer 103 while being reflected off the adjacent reflective walls 102 or the reflective layer 104, and then emitted from a surface of the transparent layer 103. In other words, a surface of the columnar transparent layer 103 corresponds to a part of a light-emitting surface of the backlight unit.

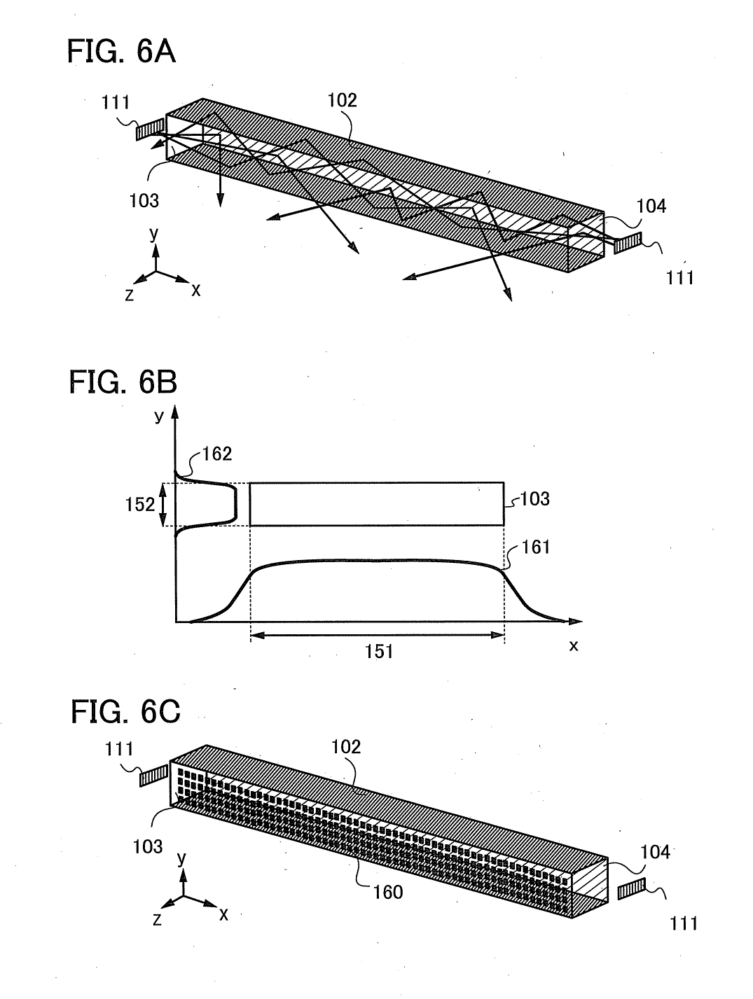

FIG. 6A is a schematic view illustrating light propagation related to one columnar transparent layer 103. Light generated in the light source 111 is propagated, as indicated by the arrows in the diagram, within the transparent layer 103 while being reflected off the adjacent reflective wall 102 or reflective layer 104, and then emitted from a surface of the transparent layer 103.

FIG. 6B illustrates intensity distribution 161 in a longitudinal direction 151 and intensity distribution 162 in a lateral direction 152 of light emitted from a surface of one columnar transparent layer 103. The longitudinal direction 151 is the direction in which the column extends. Providing the reflective walls 102 can reduce the width of the hem of the intensity distribution 162 in the lateral direction 152. Consequently, light leaking into a region other than a predetermined region can be reduced.

Note that a plurality of reflective structures 160 may be provided on a surface of the transparent layer 103 as illustrated in FIG. 6C. The structure 160 is also called a reflective dot, for example. Controlling the sizes, arrangement, and density of the structures 160 can make the intensity distribution of light emitted from the transparent layer 103 homogeneous.

Note that, in the structure in FIGS. 1A to 1D, the backlight unit may further include a diffusion sheet, a prism sheet, or a luminance increasing sheet (also called a luminance increasing film). By providing a diffusion sheet, a prism sheet, a luminance increasing sheet, or the like to a face of the light guide plate 101 through which light is emitted, the intensity distribution of light emitted from the light guide plate 101 can be made more homogeneous, and the intensity of light can be increased.

As stated above, light entering the plurality of transparent layers 103 are controlled by the respective light sources 111. Therefore, in the backlight unit whose light-emitting surface is divided into a plurality of columnar regions, the selection of the luminescent color and emitting state of each region can be made independently. Thus, color scan backlight drive can be made. The reflective walls 102 can reduce light leaking into a region other than a predetermined region, thereby relieving the color mixture problem in the backlight unit using the color scan backlight drive. At the same time, light use efficiency can be improved. Further, since the backlight unit is a side light type one in which the light sources 111 are provided to the side surfaces of the light guide plate 101 and light enters from the side surfaces, the number of light sources used in the backlight unit can be reduced, thereby achieving cost reduction.

This embodiment can be freely combined with any of the other embodiments.

### Embodiment 2

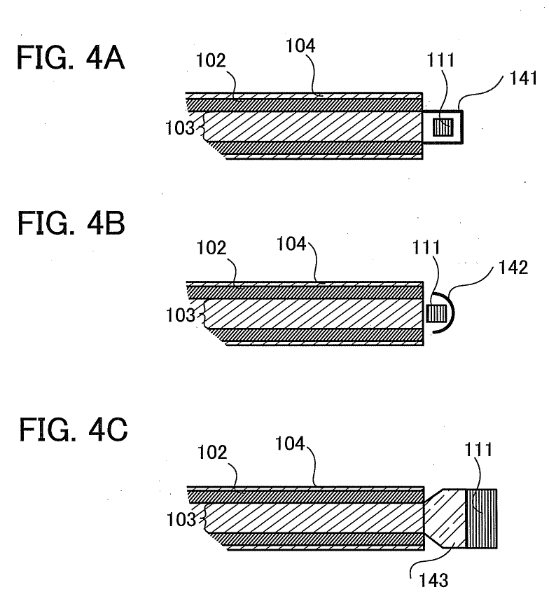

This embodiment describes one embodiment of the structure of a connecting point between the light guide plate 101 and the light sources 111 in the backlight unit having the structure described with reference to FIGS. 1A to 1D in Embodiment 1, with reference to FIGS. 4A to 4C. The reference numerals used in FIGS. 1A to 1D will be used for the description.

FIGS. 4A to 4C show, for the description, enlarged views of two adjacent reflective walls 102, a portion near the edge of the transparent layer 103, and a corresponding light source 111. In practice, as illustrated in FIGS. 1A, 1C, and 1D, the plurality of reflective walls 102, the plurality of transparent layers 103, and the plurality of light sources 111 can have the same structures as those in FIGS. 4A to 4C.

One embodiment of the structure of a connecting point between the light guide plate 101 and the light sources 111 is illustrated in FIG. 4A. The backlight unit includes a reflective mirror 141. The reflective mirror 141 is provided so as to reflect light emitted from the light source 111 and let the light into the transparent layer 103.

Another embodiment of the structure of a connecting point between the light guide plate 101 and the light sources 111 is illustrated in FIG. 4B. The backlight unit includes a condenser lens 142. The condenser lens 142 is provided so as to condense light emitted from the light source 111 and let the light in the transparent layer 103.

Another embodiment of the structure of a connecting point between the light guide plate 101 and the light sources 111 is illustrated in FIG. 4C. The backlight unit includes an optical fiber 143. The optical fiber 143 is provided so as to propagate light emitted from the light source 111 and let the light into the transparent layer 103.

The structures in FIGS. 4A to 4C allows light emitted from the light source 111 to enter the transparent layer 103 efficiently.

This embodiment can be freely combined with any of the other embodiments.

### Embodiment 3

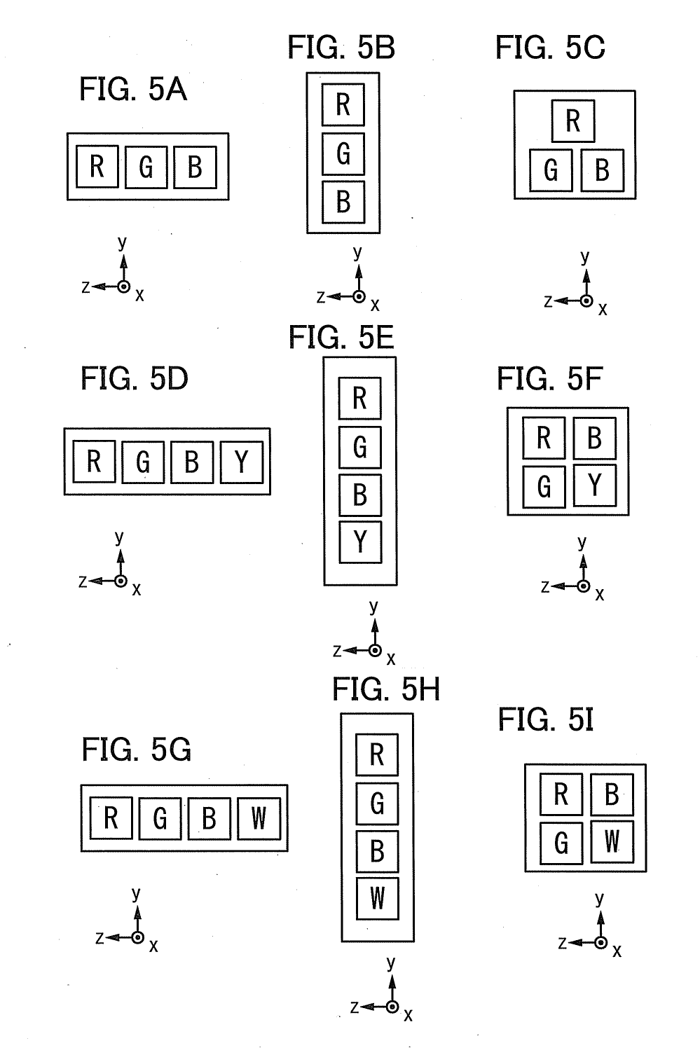

This embodiment describes one embodiment of the structure of the light source 111 in the backlight unit having the structure described with reference to FIGS. 1A to 1D in Embodiment 1, with reference to FIGS. 5A to 5I.

The light source 111 can be formed by the combination of a plurality of light sources, e.g., the combination of light sources of colors that produce white by addictive color mixture. For example, the light source 111 can be formed by the combination of a red light source (R), a green light source (G), and a blue light source (B). For another example, the light source 111 can be formed by the combination of a red light source (R), a green light source (G), a blue light source (B), and a light source of another color. The other color may be one or more of the following: yellow, cyan, magenta, and the like. Alternatively, the other color may be white. The light source can be a light-emitting diode, an organic EL element, or the like.

FIGS. 5A to 5C each illustrate an example of the arrangement of these light sources in the case where the light source 111 is formed by the combination of a red light source (R), a green light source (G), and a blue light source (B).

FIGS. 5D to 5F each illustrate an example of the arrangement of these light sources in the case where the light source 111 is formed by the combination of a red light source (R), a green light source (G), a blue light source (B), and a light source of any one of the following: yellow, cyan, magenta, and the like (denoted by Y in the diagram).

FIGS. 5G to 5I each illustrate an example of the arrangement of these light sources in the case where the light source 111 is formed by the combination of a red light source (R), a green light source (G), a blue light source (B), and a white light source (denoted by W in the diagram).

Note that light of a predetermined color may be generated using a conversion filter or the like instead of providing a light source generating light of each color.

This embodiment can be freely combined with any of the other embodiments.

### Embodiment 4

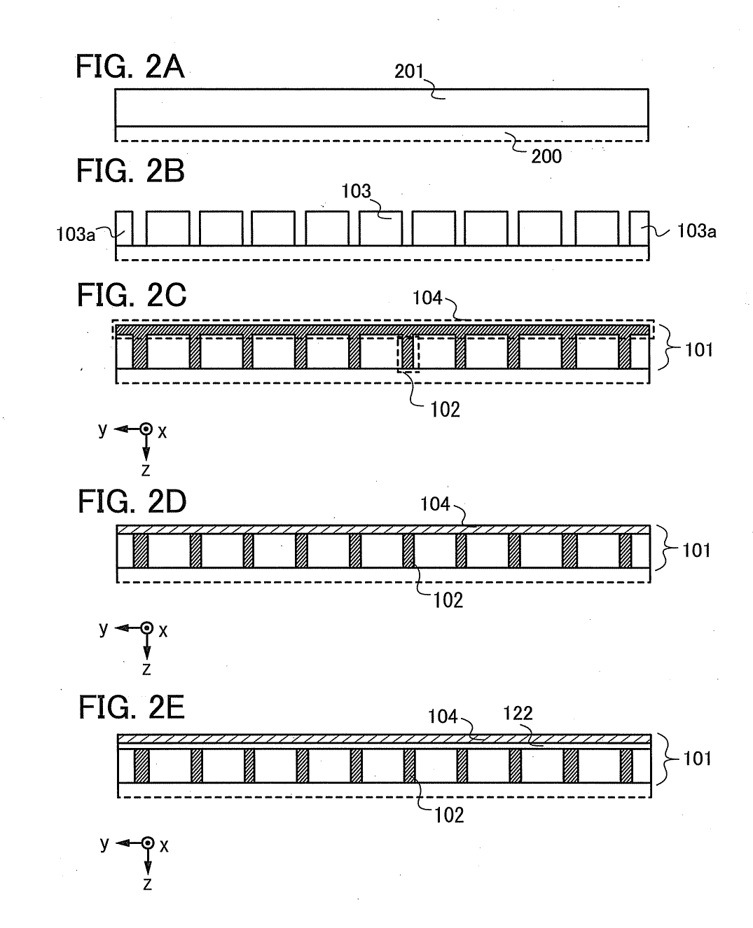

This embodiment shows one embodiment of a method for fabricating a backlight unit having the structure described with reference to FIGS. 1A to 1D in Embodiment 1. The description is made with reference to FIGS. 2A to 2E, FIGS. 16A to 16C, and FIGS. 3A to 3F.

A transparent film 201 is formed over a surface 200 as illustrated in FIG. 2A. The material for the transparent film 201 may be inorganic glass (with a refractive index of 1.42 to 1.7 and a transmission factor of 80 to 91%), such as quartz and borosilicate glass, or plastic material (resin material). This plastic can be material mixed with any of the following resins: methacrylic resins such as polymethyl methacrylate (with a refractive index of 1.49 and a transmission factor of 92 to 93%) known as acrylic, polycarbonate (with a refractive index of 1.59 and a transmission factor of 88 to 90%), polyarylate (with a refractive index of 1.61 and a transmission factor of 85%), poly-4-methylpentene-1 (with a refractive index of 1.46 and a transmission factor of 90%), AS resin [acrylonitrile-styrene polymer] (with a refractive index of 1.57 and a transmission factor of 90%), and MS resin [methyl methacrylate-styrene polymer] (with a refractive index of 1.56 and a transmission factor of 90%). Note that the material for the transparent film 201 is not limited to this and can be any light-transmitting material.

The surface 200 is a surface of any substrate, sheet, or the like of light-transmitting material. For example, the surface 200 may be either a plastic substrate surface or a glass substrate surface. Alternatively, the surface 200 may be a surface of a substrate or optical sheet (that corresponds to a deflection plate or the like) contained in a display panel which forms a display device in combination with a backlight unit.

Next, as illustrated in FIG. 2B, the transparent film 201 is subjected to etching, thereby forming the plurality of transparent layers 103. Although FIG. 2B illustrates the case where edges of the transparent layer 103a are formed, the edges of the transparent layer 103a may be removed by etching.

Subsequently, the reflective walls 102 and the reflective layer 104 are formed using reflective material as illustrated in FIG. 2C. FIG. 2C shows a case where the reflective walls 102 and the reflective layer 104 are formed integrally using the same material, but one embodiment of the present invention is not limited to this. For example, it is acceptable that, as illustrated in FIG. 2D, the reflective walls 102 are formed so as to fill the spaces between the plurality of transparent layers 103, and then the reflective layer 104 is formed. It is also acceptable that, as illustrated in FIG. 2E, the reflective walls 102 are formed so as to fill the spaces between the plurality of transparent layers 103, and then an adhesive layer 122 is formed, and then the reflective layer 104 is formed. In this case, it is acceptable that the reflective layer 104 is used as a reflective sheet, and the reflective sheet, the plurality of transparent layers 103, and the reflective walls 102 are attached to each other by the adhesive layer 122. In FIG. 2E, there are spaces between the reflective layer 104 and each reflective wall 102. Note that, in the structures in FIGS. 2D and 2E, the reflective walls 102 and the reflective layer 104 can be of different materials.

Thus, the light guide plate 101 is fabricated and the light sources 111 and the like are provided, so that the backlight unit can be fabricated.

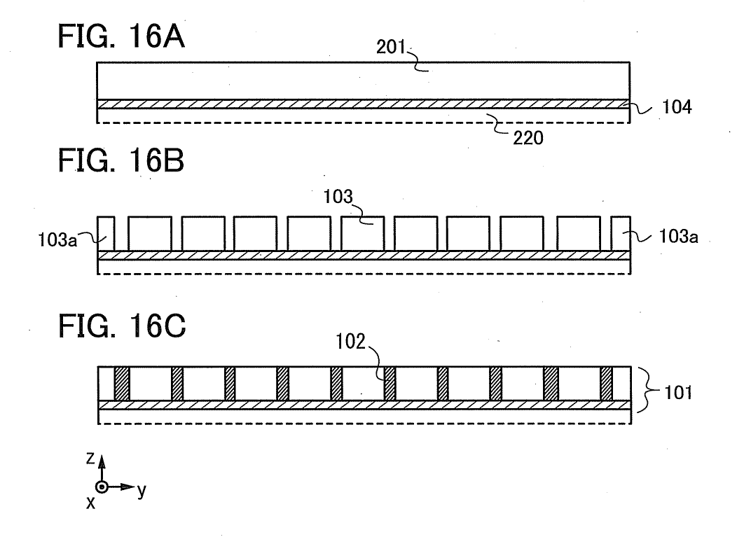

One embodiment of a method for fabricating a backlight unit different from that illustrated in FIGS. 2A to 2E will be illustrated in FIGS. 16A to 16C.

As illustrated in FIG. 16A, the reflective layer 104 is formed over a surface 220 by using reflective material. The transparent film 201 is formed over the reflective layer 104. The material for the transparent film 201 may be the same as any of the materials listed for the description of FIGS. 2A to 2E.

The surface 220 is a surface of any substrate, sheet, or the like.

Next, as illustrated in FIG. 16B, the transparent film 201 is subjected to etching, forming the plurality of transparent layers 103. Although FIG. 16B illustrates the case where edges of the transparent layer 103a are formed, the edges of the transparent layer 103a may be removed by etching.

Subsequently, the reflective walls 102 are formed using reflective material so as to fill the spaces between the plurality of transparent layers 103 as illustrated in FIG. 16C. FIG. 16C shows the case where the reflective walls 102 and the reflective layer 104 are of different materials, but one embodiment of the present invention is not limited to this; they may be of the same material.

Thus, the light guide plate 101 is fabricated and the light sources 111 and the like are provided, thereby fabricating the backlight unit.

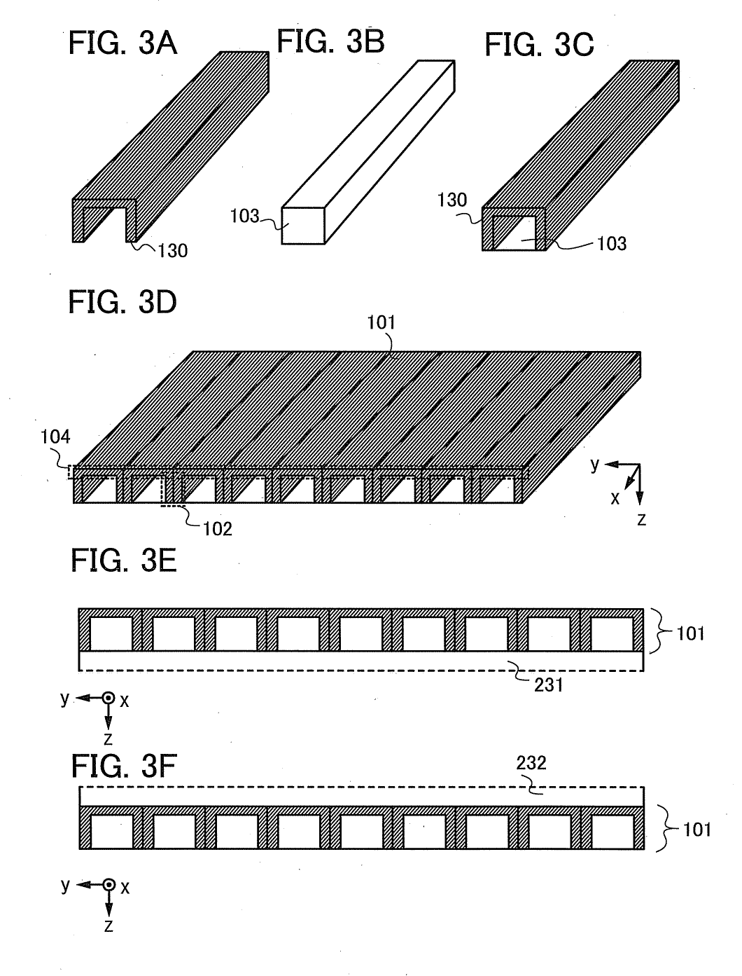

One embodiment of a method for fabricating a backlight unit different from that illustrated in FIGS. 2A to 2E or FIGS. 16A to 16C will be illustrated in FIGS. 3A to 3F. As illustrated in FIG. 3A, a member 130 having section in the channel shape and extending in one direction is fabricated by using reflective material. Moreover, the transparent layer 103 of light-transmitting material in the columnar shape (the cuboid shape) is formed as illustrated in FIG. 3B. Then, as illustrated in FIG. 3C, the transparent layer 103 is embedded in the member 130.

Note that a member having the structure illustrated in FIG. 3C can be formed also by applying reflective paint to a surface of one like the transparent layer 103 of light-transmitting material in the columnar shape (the cuboid shape) illustrated in FIG. 3B. The reflective paint can be white paint, for example.

A plurality of members each having the structure illustrated in FIG. 3C is formed. Then, as illustrated in FIG. 3D, the plurality of members is combined, thereby forming the light guide plate 101.

The light guide plate 101 may be formed by attaching a plurality of members each having the structure illustrated in FIG. 3C to a surface 231, as illustrated in FIG. 3E. Note that, in FIG. 3E, there is no adhesive layer for bonding the member 130 in the channel shape and the transparent layer 103 to the surface 231, but an adhesive layer may be provided.

The surface 231 is a surface of any substrate, sheet, or the like of light-transmitting material. For example, the surface 231 may be either a plastic substrate surface or a glass substrate surface. Alternatively, the surface 231 may be a surface of a substrate or optical sheet (that corresponds to a deflection plate or the like) contained in a display panel which forms a display device in combination with a backlight unit.

Unlike in FIG. 3E, the light guide plate 101 may be formed by attaching a plurality of members each having the structure illustrated in FIG. 3C to a surface 232, as illustrated in FIG. 3F. Note that, in FIG. 3F, there is no adhesive layer for bonding the member 130 in the channel shape to the surface 232, but an adhesive layer may be provided.

Thus, the light guide plate 101 is fabricated and the light sources 111 and the like are provided, thereby fabricating the backlight unit.

Note that the reflective material can be, for example, aluminum, silver, gold, platinum, copper, an alloy containing aluminum, or an alloy containing silver. Note that the reflective wall 102 or the reflective layer 104 may be either of one layer or of a plurality of layers. The reflective material may be reflective paint, e.g., white paint.

An adhesive layer (e.g. the adhesive layer 122) used in the backlight unit is a light-transmitting adhesive and preferably has a refractive index that is made as close as possible to the refractive index of a substrate or sheet that has the surface 200, or the transparent layer 103. For example, an adhesive containing an epoxy resin, an adhesive containing a urethane resin, or an adhesive containing a silicone resin can be used. The method for forming the adhesive layer is selected from the following: a droplet discharge method, coating, spin coating, dip coating, and the like, according to the selected material. Further, the adhesive layer may be formed using a tool such as a doctor knife, a roll coater, a curtain coater, or a knife coater.

The materials for members included in the backlight unit, in which light from the light source is propagated (the transparent layer 103, the adhesive layer, a diffusion sheet, a prism sheet, and the like), preferably have refractive indexes made as close as possible (so that a difference between the refractive indexes may be 0.15 or less). This reduces stray light due to reflection caused by the difference in refractive index, thereby efficiently utilizing light generated in the light source 111 as light emitted from the backlight unit.

This embodiment can be freely combined with any of the other embodiments.

### Embodiment 5

This embodiment shows one embodiment of the structure of a display device using a backlight unit having the structure that has been described with reference to FIGS. 1A to 1D in Embodiment 1.

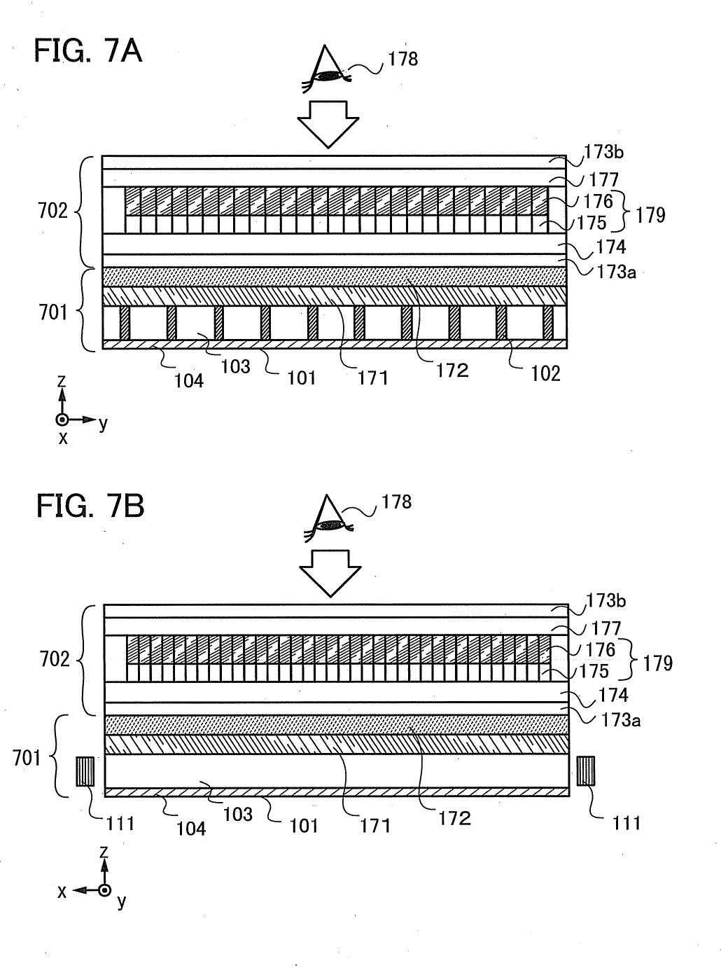

FIGS. 7A and 7B illustrate the cross-sectional structure of the display device. FIG. 7A is a cross-sectional view in which the display device is viewed in the x direction. FIG. 7B is a cross-sectional view in which the display device is viewed in the y direction.

In FIGS. 7A and 7B, the display device includes a backlight unit 701 and a display panel 702 irradiated with light from the backlight unit 701. A user's eye 178 sees the display device in the direction indicated by the white arrow and perceives an image.

The display panel 702 includes an element substrate 174, a plurality of pixels 179 provided over the element substrate 174, a substrate 177 opposed to the element substrate 174, and polarizers 173a and 173b. The element substrate 174 and the substrate 177 need to be light-transmitting substrates to transmit light emitted from the backlight unit 701. FIGS. 7A and 7B illustrate the structure in which polarizers 173a and 173b are provided, but one embodiment of the present invention is not limited to this. It is acceptable that more polarizers are provided or no polarizer is provided.

The plurality of pixels 179 is arranged in a matrix over the element substrate 174. The pixel 179 can include a switching element 175 and a display element 176. The display element 176 can be a liquid crystal element. Note that the display element 176 can be any element as long as it controls whether light is transmitted or not, and may thus be, for example, a micro electro mechanical system (MEMS) instead of a liquid crystal element. The switching element 175 can be a transistor. The transistor may be either one using a semiconductor such as silicon or one using an oxide semiconductor in the active layer.

The backlight unit 701 includes the light sources 111, the light guide plate 101, a diffusion sheet 171, and a prism sheet 172. FIGS. 7A and 7B illustrate the structure in which the diffusion sheet 171 and the prism sheet 172 are provided, but one embodiment of the present invention is not limited to this. It is acceptable that more diffusion sheets or prism sheets are provided or none of these sheets is provided. It is also acceptable that a luminance increasing sheet (a luminance increasing film) is provided. The structure of the light guide plate 101 is the same as the structure illustrated in FIGS. 1A to 1D and the like; thus, its description is omitted.

FIGS. 7A and 7B illustrate the structure in which the pixels 179 are arranged in a matrix with 27 rows and 36 columns over the element substrate 174, and pixels in a matrix with 3 rows and 36 columns are arranged so as to overlap with one columnar transparent layer 103, but one embodiment of the present invention is not limited to this. The number of the pixels 179 overlapping with one columnar transparent layer 103 can be any number. The number of the reflective walls 102 or columnar transparent layers 103 can also be any number.

The structure in FIGS. 7A and 7B lets light from the columnar transparent layers 103 included in the backlight unit 701 into a plurality of rows of pixels 179. Further, the backlight unit 701 performs color scan backlight drive; thus, the display device can display an image by the field sequential system.

Note that, in a display device in which the backlight unit 701 and the display panel 702 overlap with each other like that in FIGS. 7A and 7B, the materials for members in which light from the light source 111 is propagated preferably have refractive indexes made as close as possible (so that a difference between the refractive indexes may be 0.15 or less). Particularly in the case where the backlight unit 701 and the display panel 702 are firmly bonded to each other with an adhesive layer or the like to form a display device (the solid state), the materials for members in the backlight unit 701 or display panel 702, in which light from the light source 111 is propagated, and the material for the adhesive layer have preferably have refractive indexes made as close as possible (so that a difference between the refractive indexes may be 0.15 or less). This reduces stray light due to reflection caused by the difference in refractive index, thereby efficiently utilizing light generated in the light source 111 as light used for image display in the display device.

This embodiment can be freely combined with any of the other embodiments.

### Embodiment 6

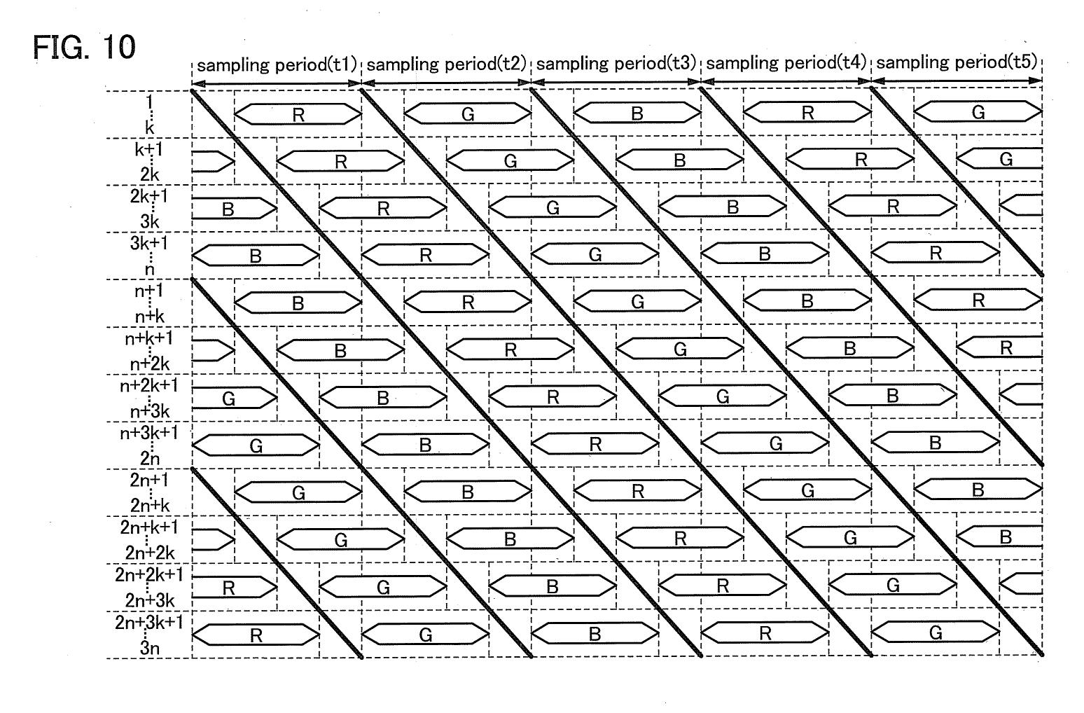

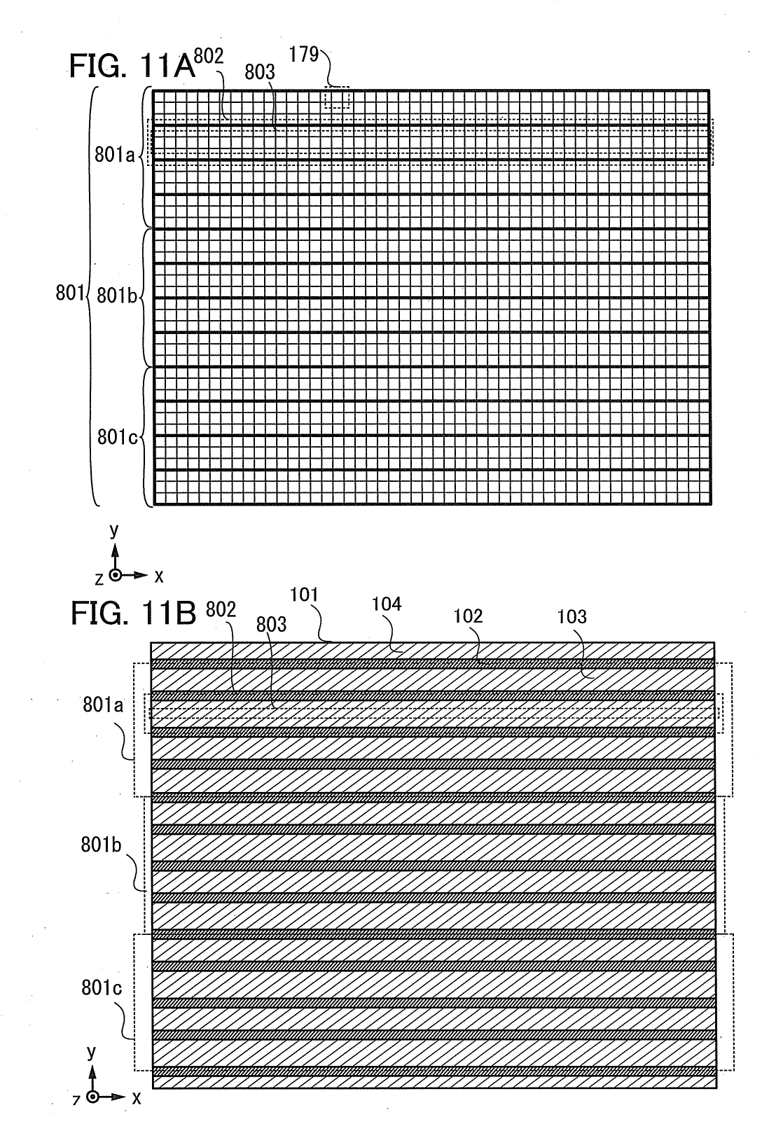

This embodiment describes one embodiment of a driving method for a display device displaying images by the field sequential system. The description is made with reference to FIG. 10, FIGS. 11A and 11B, FIGS. 12A to 12E, FIGS. 13A to 13F, and FIGS. 14A to 14F. Note that the same portions as those in FIGS. 1A to 1D and FIGS. 7A and 7B are denoted by the same reference numerals and the description thereof is omitted.

First, the specific structure of the display device will be described with reference to FIGS. 11A and 11B.

FIG. 11A is the top view of the display panel 702. The display panel 702 includes a display region 801 in which the pixels 179 are arranged in a matrix. The display region 801 is divided into a plurality of regions so that one pixel column may be divided (FIGS. 11A and 11B illustrates the case where the display region 801 is divided into three regions (a first region 801a, a second region 801b, and a third region 801c)). The row direction in the display region 801 is the direction in which the pixels 179 in the same row 803 are aligned and corresponds to the lateral direction in the drawing.

FIG. 11B is the top view of the backlight unit 701 overlapping with the display panel 702 illustrated in FIG. 11A. The columnar transparent layers 103 in the backlight unit 701 are provided so that the row direction in the display region 801 (the direction in which the pixels 179 in the same row 803 are aligned) may be substantially the same as the direction in which the columns extend. A plurality of transparent layers 103 (four transparent layers 103 in FIGS. 11A and 11B) overlaps with each of the plurality of regions (the first region 801a, the second region 801b, and the third region 801c). A plurality of rows of pixels (three rows of pixels in FIGS. 11A and 11B) overlaps with one transparent layer 103. Here, a set of pixels 802 corresponding to one transparent layer is called a block. In the structure illustrated in FIGS. 11A and 11B, the plurality of regions (the first region 801a, the second region 801b, and the third region 801c) has first to fourth blocks, respectively.

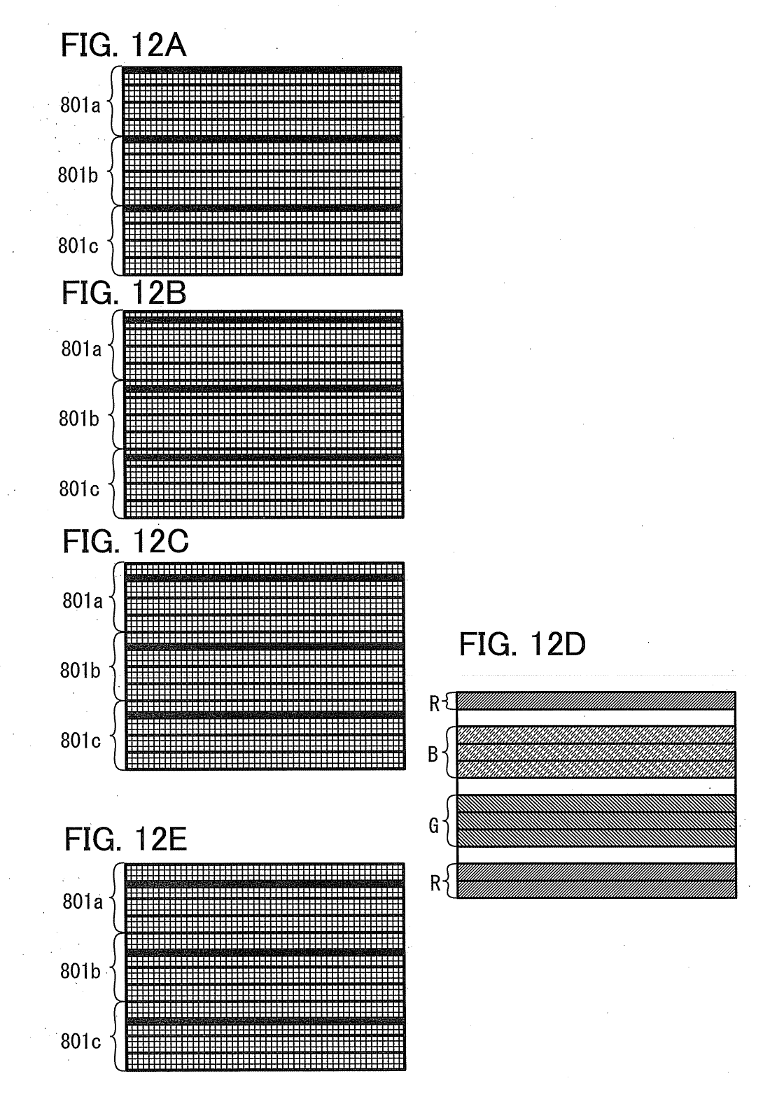

Next, one embodiment of a driving method for a display device having the structure in FIGS. 11A and 11B in which an image is displayed by the field sequential system will be described with reference to FIG. 10, FIGS. 12A to 12E, FIGS. 13A to 13F, and FIGS. 14A to 14F.

FIG. 10 illustrates scan by a selection signal (scan in the column direction) and the timing of lighting the backlight in the display device. The selection signal controls the switching of the switching element 175 in each pixel 179. When the selection signal selects a pixel 179 as a pixel to which an image signal is input, an image signal is input to the pixel 179. The vertical axis in FIG. 10 indicates the pixel row in the display region 801 in FIGS. 11A and 11B. When the display device in FIGS. 11A and 11B employs the driving method in FIG. 10, k is 3 and n is 12. The horizontal axis in FIG. 10 indicates time. In FIG. 10, the heavy line schematically indicates the timing of when an image signal is input to each pixel. In FIG. 10, “R” refers to red luminescent color and indicates that a plurality of corresponding pixels (e.g., the first to k-th pixels) is irradiated with light from the transparent layer 103. In FIG. 10, “B” refers to blue luminescent color and indicates that a plurality of corresponding pixels (e.g., the (n+1)-th to (n+k)-th pixels) is irradiated with light from the transparent layer 103. In FIG. 10, “G” refers to green luminescent color and indicates that a plurality of corresponding pixels (e.g., the (2n+1)-th to (2n+k)-th pixels) is irradiated with light from the transparent layer 103.

In the sampling period (t1), m (m is a natural number and, in FIGS. 11A and 11B, m is 50) pixels 179 provided in the first to n-th (n is a natural number and, in FIGS. 11A and 11B, n is 12) rows are selected in sequence, m pixels 179 provided in the (n+1)-th to 2n-th rows are selected in sequence, and m pixels 179 provided in the (2n+1)-th to 3n-th rows are selected in sequence; thus, an image signal is input to each pixel.

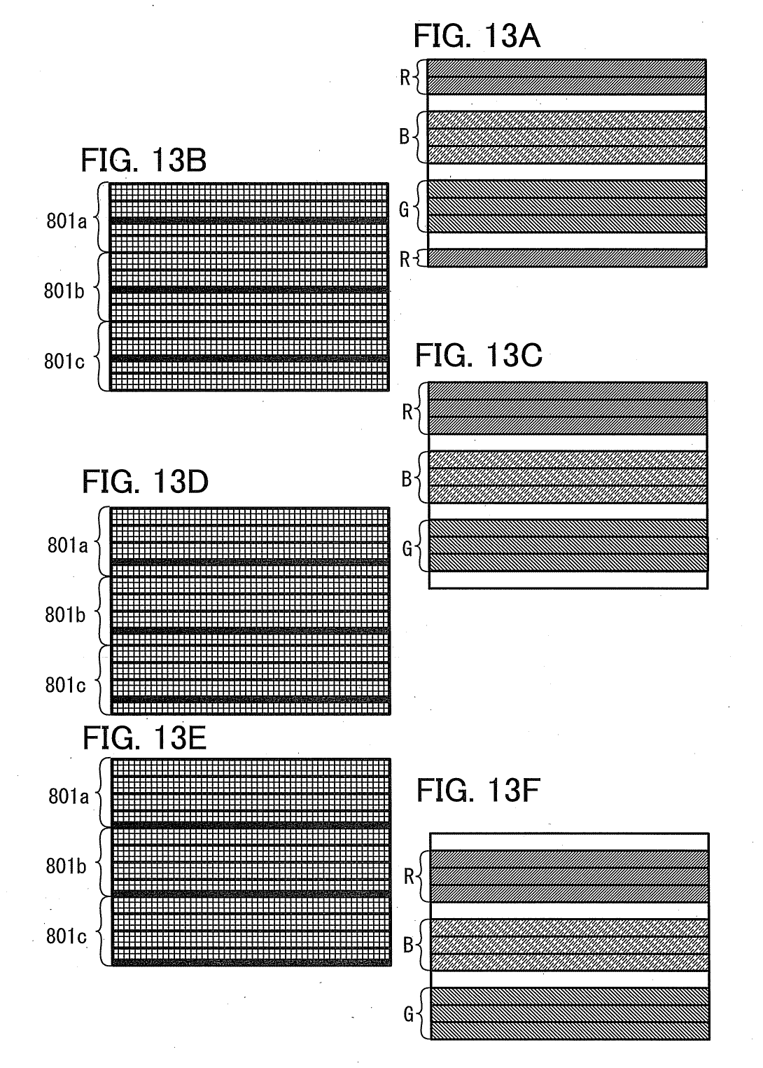

The driving method during the sampling period (t1) will be described in detail with reference to FIGS. 12A to 12E and FIGS. 13A to 13F. In FIGS. 12A to 12E, FIGS. 13A to 13F, and FIGS. 14A to 14F, black pixel rows are ones to which image signals are input. Further, R, B, and G indicate the transparent layer 103 emitting red light, the transparent layer 103 emitting blue light, and the transparent layer 103 emitting green light, respectively. A white portion corresponds to the transparent layer 103 which does not emit light (which is not lit).

At the beginning of the sampling period (t1), image signals are input to the pixels in the first, (n+1)-th, and (2n+1)-th rows simultaneously as illustrated in FIG. 12A. Alternatively, image signals may be input to the pixels in these rows in sequence. Then, as illustrated in FIG. 12B, image signals are simultaneously input to the pixels in the next rows: the second, (n+2)-th, and (2n+2)-th rows. Alternatively, image signals may be input to the pixels in these rows in sequence. In this way, in the first block in each of the plurality of regions (the first region 801a, the second region 801b, and the third region 801c), input of image signals is performed by selecting the pixel rows one by one. Subsequently, when input of image signals to the pixels in the first block in each of the plurality of regions (the first region 801a, the second region 801b, and the third region 801c) is finished to the last pixel row as illustrated in FIG. 12C, corresponding transparent layers 103 in the backlight unit 701 emit light as illustrated in FIG. 12D.

Note that, in FIG. 12D, the transparent layers 103 corresponding to the third and fourth blocks in the first region 801a emit blue light, the transparent layers 103 corresponding to the third and fourth blocks in the second region 801b emit green light, and the transparent layers 103 corresponding to the third and fourth blocks in the third region 801c emit red light. Image signals are input to the pixels in these blocks in a sampling period that precedes the sampling period (t1), so that an image based on these image signals is displayed.

Next, in the same way, image signals are input to the pixels in the second block in each of the plurality of regions (the first region 801a, the second region 801b, and the third region 801c) as illustrated in FIG. 12E. When input of image signals to the pixels in the second block in each of the plurality of regions (the first region 801a, the second region 801b, and the third region 801c) is finished to the last pixel row, corresponding transparent layers 103 in the backlight unit 701 emit light as illustrated in FIG. 13A. While input of image signals to the pixels in the second block is performed, the transparent layers 103 corresponding to the first, third, and fourth blocks emit light. In other words, the input of image signals and the lighting of the backlight unit 701 are done simultaneously.

The above-stated operation is also applied to the third and fourth blocks as illustrated in FIGS. 13B to 13E. Then, the sampling period (t1) terminates. The light-emission state of the backlight unit 701 after the sampling period (t1) can be like that shown in FIG. 13F. In FIG. 13F, the transparent layers 103 corresponding to the first blocks emit no light.

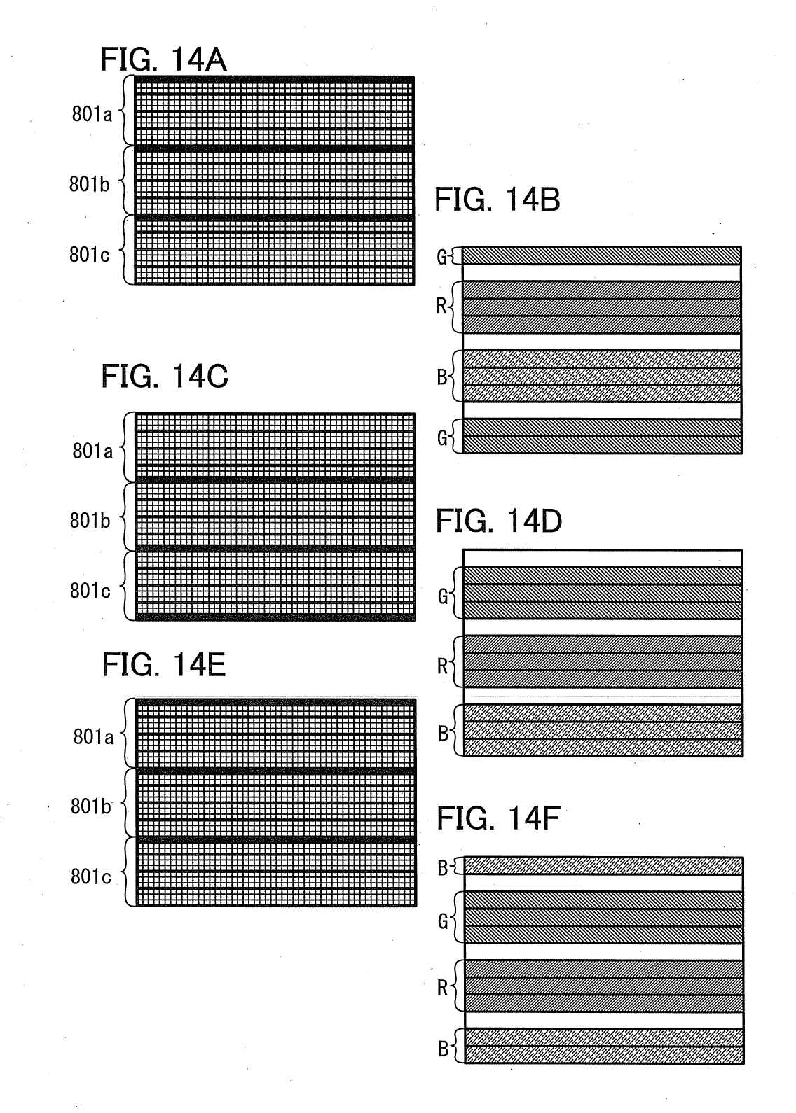

The same operation as in the sampling period (t1) is performed in the sampling period (t2) as illustrated in FIGS. 14A to 14C. However, in the plurality of regions (the first region 801a, the second region 801b, and the third region 801c), the sampling period (t1) differs from the sampling period (t2) in the color of light emitted by each transparent layer 103 in the backlight unit 701. The light-emission state of the backlight unit 701 after the sampling period (t2) can be that shown in FIG. 14D. In FIG. 14D, the transparent layers 103 corresponding to the first blocks emit no light.

The same operation as in the sampling period (t1) or (t2) is performed in the sampling period (t3) as illustrated in FIG. 14E. However, in the plurality of regions (the first region 801a, the second region 801b, and the third region 801c), the color, of light emitted by each transparent layer 103 in the backlight unit 701 is different from in the sampling period (t1) or (t2). In the sampling period (t3), the light-emission state of the backlight unit 701 after the writing of image signals to the pixels in the first block can be that shown in FIG. 14F. In FIG. 14F, the transparent layers 103 corresponding to the second blocks emit no light.

Operations in the sampling periods (t1) to (t3) produce one image on the display region 801. In other words, the sampling periods (t1) to (t3) correspond to one frame period.

Note that the driving method described with reference to FIG. 10, FIGS. 12A to 12E, FIGS. 13A to 13F, and FIGS. 14A to 14F employs light of three colors: red (R), green (G), and blue (B) as a backlight, but one embodiment of the present invention is not limited to this. In other words, the combination of backlights producing any colors can be used. The number of the sampling periods in one frame period can be set in accordance with the number of colors used for backlights. Note that the number of sampling periods in one frame period can be set to any number. Further, one frame period may contain a period in which the backlight is not lit.

As described above, the driving method described with reference to FIG. 10, FIGS. 12A to 12E, FIGS. 13A to 13F, and FIGS. 14A to 14F can increase the frequency of input of an image signal to each pixel by supplying image signals to a plurality of rows of pixels simultaneously without changing the response speed of the switching element included in the display device, such as a transistor. For example, the driving method described with reference to FIG. 10, FIGS. 12A to 12E, FIGS. 13A to 13F, and FIGS. 14A to 14F can triple the frequency of input of an image signal to each pixel without changing the clock frequency of a driver circuit or the like.

In a field-sequential display device, color information is time-divided. Consequently, an image viewed by the user may change (degrade) from an image based on the original display data (such a phenomenon is also called color break or color breakup) owing to the miss of particular display information due to a short-time cutoff from the image such as the user's blinking eyes. Here, increasing the frame frequency is effective in reducing color breaks. However, in order to display an image by the field sequential system, the frequency of inputting an image signal to each pixel needs to be higher than the frame frequency. Thus, in order to display an image with a conventional display device using the field sequential system and high frame frequency drive, the elements in the display device are required to achieve extremely high performance (high-speed response). In contrast, with the driving method described with reference to FIG. 10, FIGS. 12A to 12E, FIGS. 13A to 13F, and FIGS. 14A to 14F, image signals are supplied to a plurality of rows of pixels simultaneously, thereby increasing the frequency of inputting an image signal to each pixel without being limited by the characteristics of the elements. This facilitates the reduction in color breaks in the field-sequential display device.

Simultaneously letting different colors of light from the backlight unit 701 into different portions of the display region 801 as in the driving method described with reference to FIG. 10, FIGS. 12A to 12E, FIGS. 13A to 13F, and FIGS. 14A to 14F is preferable for a field-sequential display device in the following points. In the case where light of one color from the backlight unit 701 is let into the whole display region 801, color information about only a particular color is present on the display region 801 in a particular moment. Therefore, the miss of display information in a particular period due to the user's blinking eyes or the like leads to the miss of particular color information. In contrast, in the case where light of different colors from the backlight unit 701 are simultaneously let into different portions of the display region 801, color information about a plurality of colors is present on the display region 801 in a particular moment. Therefore, the miss of display information in a particular period due to the user's blinking eyes or the like does not lead to the miss of particular color information. In other words, simultaneously letting different colors of light from the backlight unit 701 into different portions of the display region 801 can reduce color break. Further, the driving method described with reference to FIG. 10, FIGS. 12A to 12E, FIGS. 13A to 13F, and FIGS. 14A to 14F is one in which light of different colors from the backlight unit 701 are not let into the adjacent blocks in the display region 801, thereby reducing influence of color mixture.

This embodiment can be freely combined with any of the other embodiments.

### Embodiment 7

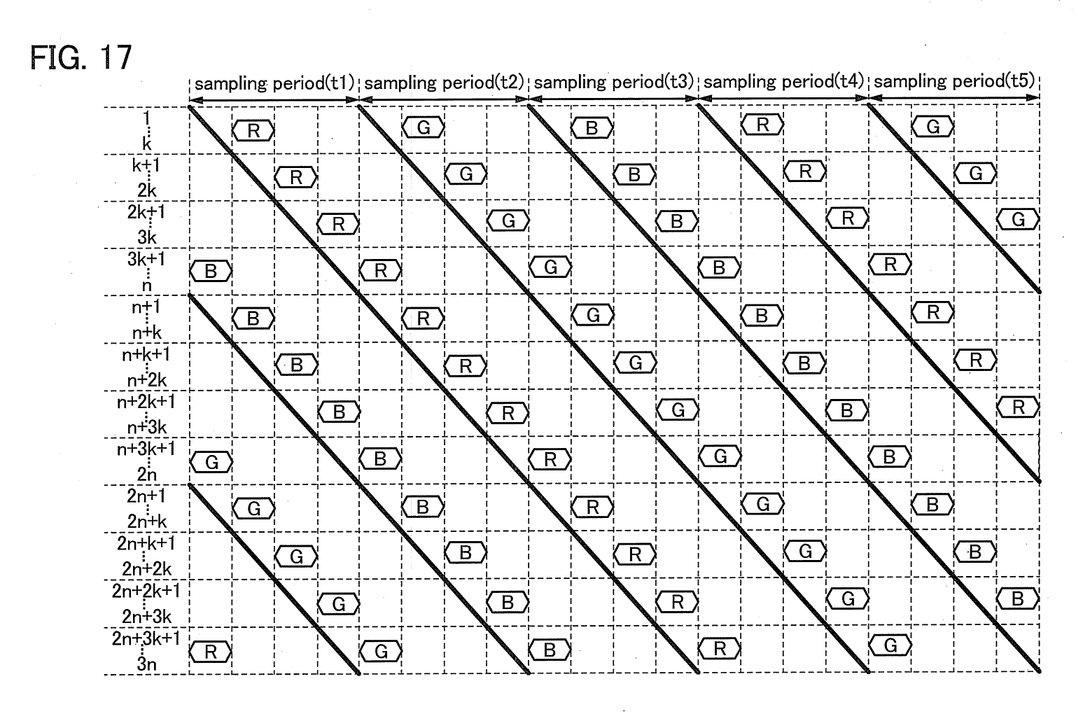

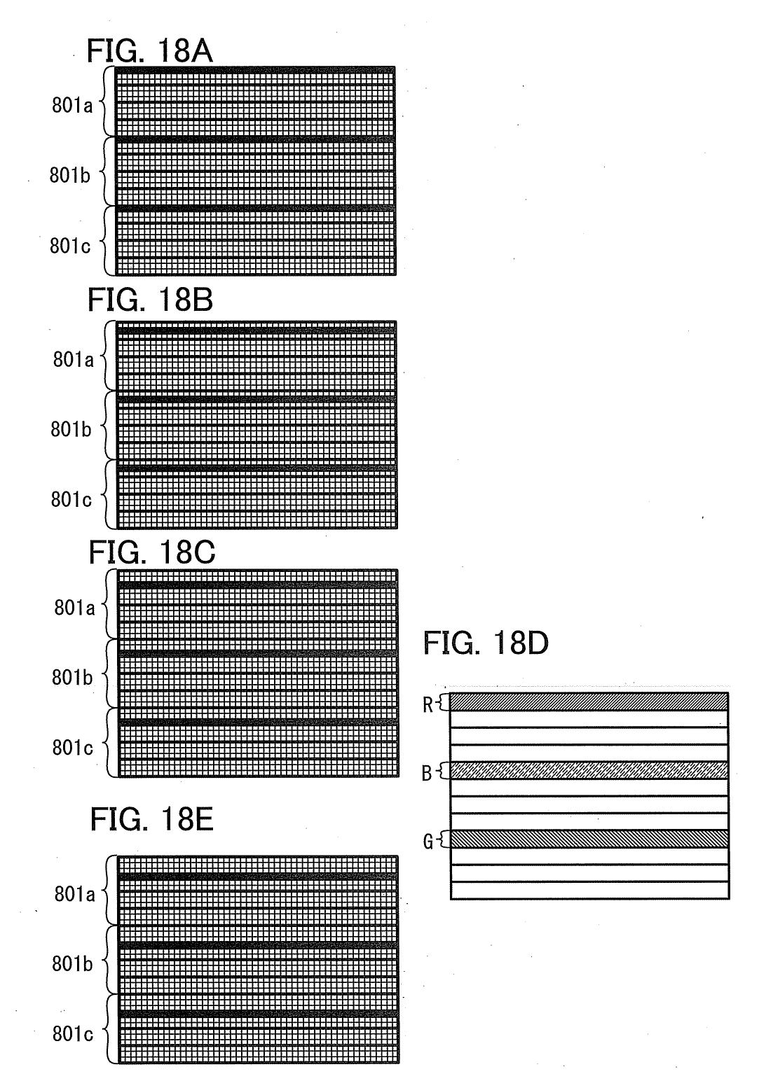

This embodiment describes a driving method for a display device displaying images by the field sequential system, which is a driving method different from the driving method in Embodiment 6. The description is made with reference to FIG. 17, FIGS. 18A to 18E, FIGS. 19A to 19F, FIGS. 20A to 20F, and FIG. 21. Note that the same portions as those in FIGS. 1A to 1D, FIGS. 7A and 7B, and FIGS. 11A and 11B are denoted by the same reference numerals and the description thereof is omitted.

The structure of the display device is the same as that described with reference to FIGS. 11A and 11B in Embodiment 6; thus, its specific description is omitted.

Embodiment 6 describes the case where the transparent layers 103 in three blocks emit light at the same time in each of the plurality of regions (the first region 801a, the second region 801b, and the third region 801c) in the driving method described with reference to FIG. 10, FIGS. 12A to 12E, FIGS. 13A to 13F, and FIGS. 14A to 14F. However, one embodiment of the present invention is not limited to this. In each of the plurality of regions (the first region 801a, the second region 801b, and the third region 801c), the number of blocks in which the transparent layers 103 emit light at the same time can be any number.

This embodiment describes the case where, in each of the plurality of regions (the first region 801a, the second region 801b, and the third region 801c), the number of blocks in which the transparent layers 103 emit light at the same time is one.

FIG. 17 illustrates scan by the selection signal (scan in the column direction) and the timing of lighting the backlight in the display device. The selection signal controls the switching of the switching element 175 in each pixel 179. When the selection signal selects a pixel 179 as a pixel to which an image signal is input, an image signal is input to the pixel 179. The vertical axis in FIG. 17 indicates the pixel row in the display region 801 in FIGS. 11A and 11B. When the display device in FIGS. 11A and 11B employs the driving method in FIG. 17, k is 3 and n is 12. The horizontal axis in FIG. 17 indicates time. In FIG. 17, the heavy line schematically indicates the timing of when an image signal is input to each pixel. In FIG. 17, “R” refers to red luminescent color and indicates that a plurality of corresponding pixels (e.g., the first to k-th pixels) is irradiated with light from the transparent layer 103. In FIG. 17, “B” refers to blue luminescent color and indicates that a plurality of corresponding pixels (e.g., the (n+1)-th to (n+k)-th pixels) is irradiated with light from the transparent layer 103. In FIG. 17, “G” refers to green luminescent color and indicates that a plurality of corresponding pixels (e.g., the (2n+1)-th to (2n+k)-th pixels) is irradiated with light from the transparent layer 103.

In the sampling period (t1), m (m is a natural number and, in FIGS. 11A and 11B, m is 50) pixels 179 provided in the first to n-th (n is a natural number and, in FIGS. 11A and 11B, n is 12) rows are selected in sequence, m pixels 179 provided in the (n+1)-th to 2n-th rows are selected in sequence, and m pixels 179 provided in the (2n+1)-th to 3n-th rows are selected in sequence; thus, an image signal is input to each pixel.

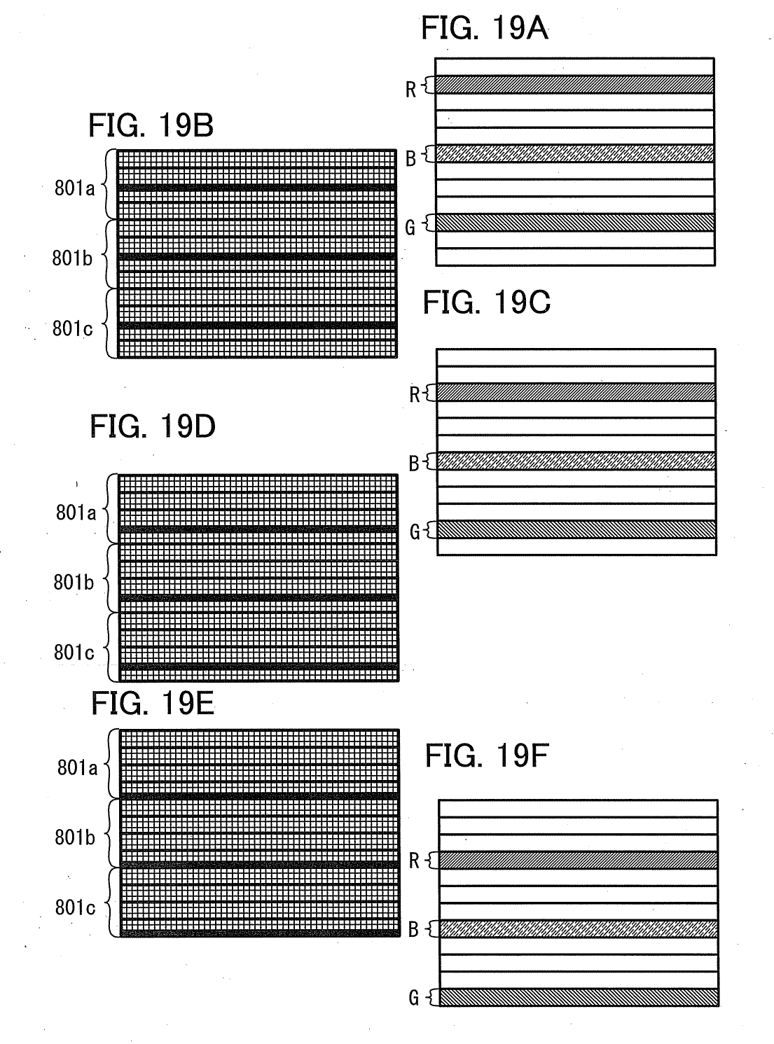

The driving method during the sampling period (t1) will be described in detail with reference to FIGS. 18A to 18E and FIGS. 19A to 19F. In FIGS. 18A to 18E, FIGS. 19A to 19F, and FIGS. 20A to 20F, black pixel rows are ones to which image signals are input. Further, R, B, and G indicate the transparent layer 103 emitting red light, the transparent layer 103 emitting blue light, and the transparent layer 103 emitting green light, respectively. A white portion corresponds to the transparent layer 103 which does not emit light (which is not lit).

At the beginning of the sampling period (t1), image signals are input to the pixels in the first, (n+1)-th, and (2n+1)-th rows simultaneously as illustrated in FIG. 18A. Alternatively, image signals may be input to the pixels in these rows in sequence. Then, as illustrated in FIG. 18B, image signals are simultaneously input to the pixels in the next rows: the second, (n+2)-th, and (2n+2)-th rows. Alternatively, image signals may be input to the pixels in these rows in sequence. In this way, in the first block in each of the plurality of regions (the first region 801a, the second region 801b, and the third region 801c), input of image signals is performed by selecting the pixel rows one by one. Subsequently, when input of image signals to the pixels in the first block in each of the plurality of regions (the first region 801a, the second region 801b, and the third region 801c) is finished to the last pixel row as illustrated in FIG. 18C, corresponding transparent layers 103 in the backlight unit 701 emit light as illustrated in FIG. 18D.

Next, in the same way, image signals are input to the pixels in the second block in each of the plurality of regions (the first region 801a, the second region 801b, and the third region 801c) as illustrated in FIG. 18E. When input of image signals to the pixels in the second block in each of the plurality of regions (the first region 801a, the second region 801b, and the third region 801c) is finished to the last pixel row, corresponding transparent layers 103 in the backlight unit 701 emit light as illustrated in FIG. 19A. While input of image signals to the pixels in the second block is performed, the transparent layers 103 corresponding to the first block emit light. In other words, the input of image signals and the lighting of the backlight unit 701 are done simultaneously.

The above-stated operation is also applied to the third and fourth blocks as illustrated in FIGS. 19B to 19E. Then, the sampling period (t1) terminates. The light-emission state of the backlight unit 701 after the sampling period (t1) can be that shown in FIG. 19F.

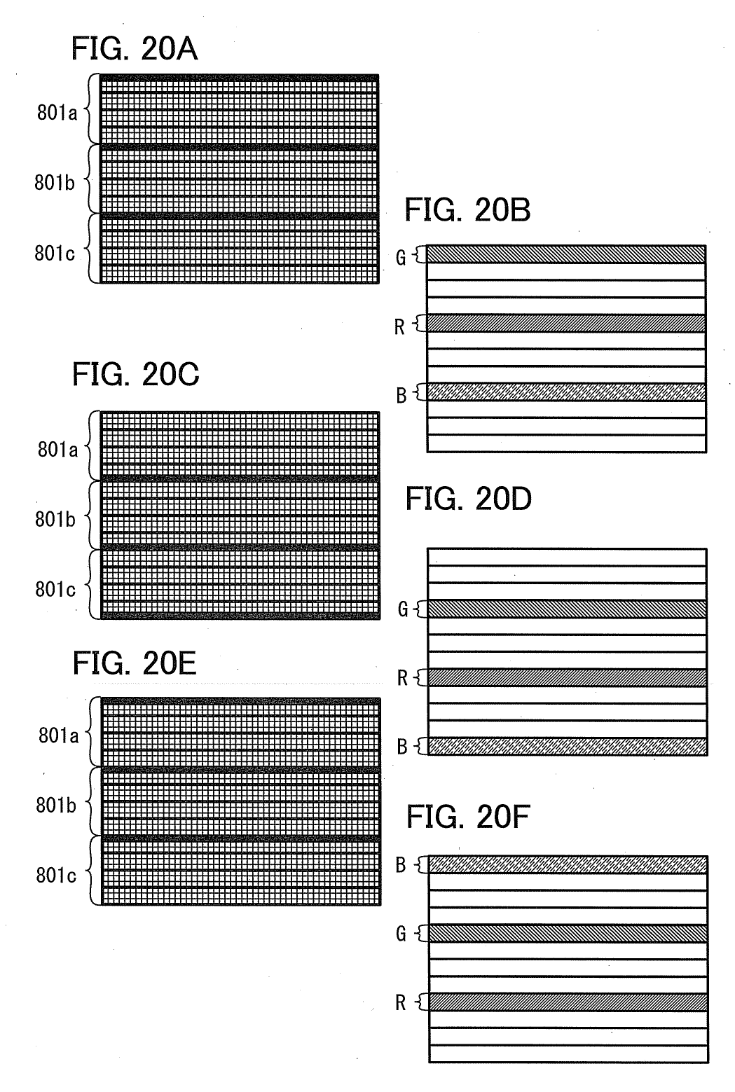

The same operation as in the sampling period (t1) is performed in the sampling period (t2) as illustrated in FIGS. 20A to 20C. However, in the plurality of regions (the first region 801a, the second region 801b, and the third region 801c), the sampling period (t1) differs from the sampling period (t2) in the color of light emitted by each transparent layer 103 in the backlight unit 701. The light-emission state of the backlight unit 701 after the sampling period (t2) can be that shown in FIG. 20D.

The same operation as in the sampling period (t1) or (t2) is performed in the sampling period (t3) as illustrated in FIG. 20E. However, in the plurality of regions (the first region 801a, the second region 801b, and the third region 801c), the color of light emitted by each transparent layer 103 in the backlight unit 701 is different from in the sampling period (t1) or (t2). In the sampling period (t3), the light-emission state of the backlight unit 701 after the writing of image signals to the pixels in the first block can be that shown in FIG. 20F.

Operations in the sampling periods (t1) to (t3) produce one image on the display region 801. In other words, the sampling periods (t1) to (t3) correspond to one frame period.

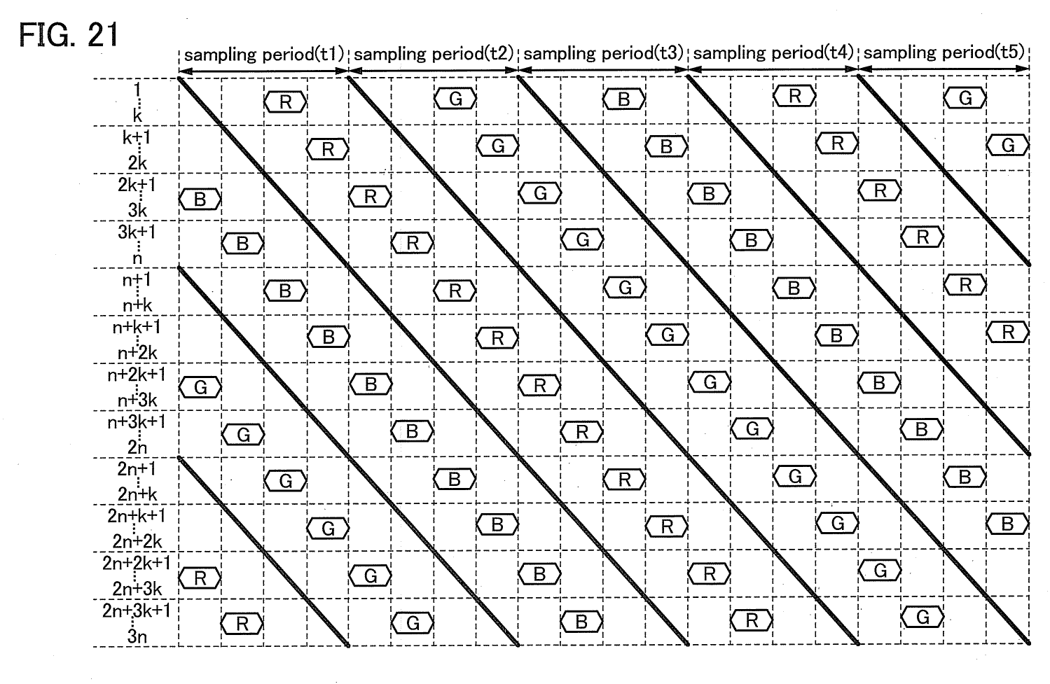

Note that the case where a transparent layer 103 is made to emit light immediately after the end of input of an image signal to a corresponding pixel row has been described for the driving method described with reference to FIG. 17, FIGS. 18A to 18E, FIGS. 19A to 19F, and FIGS. 20A to 20F, but one embodiment of the present invention is not limited to this. The corresponding transparent layer 103 may be made to emit light for a while after the end of input of an image signal. An example of such a driving method is illustrated in the timing diagram of FIG. 21. Note that this driving method is basically the same as the driving method described with reference to FIG. 17, FIGS. 18A to 18E, FIGS. 19A to 19F, and FIGS. 20A to 20F; thus, its specific description is omitted. Time from the end of the input of an image signal to when the corresponding transparent layer 103 is made to emit light can be determined, for example, on the basis of the response time of the display element. This can be determined on the basis of the response time of the liquid crystal element in the case where a liquid crystal element is used as the display element. By making the corresponding transparent layer 103 emit light after adequate response of a display element such as a liquid crystal element, accurate display based on the image signal can be achieved.

Note that the driving method described with reference to FIG. 17, FIGS. 18A to 18E, FIGS. 19A to 19F, FIGS. 20A to 20F, and FIG. 21 employs light of three colors: red (R), green (G), and blue (B) as a backlight, but one embodiment of the present invention is not limited to this. In other words, the combination of backlights presenting any colors can be used. The number of sampling periods in one frame period can be set in accordance with the number of colors used for backlights. Note that the number of the sampling periods in one frame period can be set to any number. Further, one frame period may contain a period in which the backlight is not lit.

As described above, the driving method described with reference to FIG. 17, FIGS. 18A to 18E, FIGS. 19A to 19F, FIGS. 20A to 20F, and FIG. 21 can increase the frequency of input of an image signal to each pixel by supplying image signals to a plurality of rows of pixels simultaneously without changing the response speed of the switching element included in the display device, such as a transistor. For example, the driving method described with reference to FIG. 17, FIGS. 18A to 18E, FIGS. 19A to 19F, FIGS. 20A to 20F, and FIG. 21 can triple the frequency of input of an image signal to each pixel without changing the clock frequency of a driver circuit or the like.

In a field-sequential display device, color information is time-divided. Consequently, an image viewed by the user may change (degrade) from an image based on the original display data (such a phenomenon is also called color break or color breakup) owing to the miss of particular display information due to a short-time cutoff from the image such as the user's blinking eyes. Here, increasing the frame frequency is effective in reducing color breaks. However, in order to display an image by the field sequential system, the frequency of inputting an image signal to each pixel needs to be higher than the frame frequency. Thus, in order to display an image with a conventional display device using the field sequential system and high frame frequency drive, the elements in the display device are required to achieve extremely high performance (high-speed response). In contrast, with the driving method described with reference to FIG. 17, FIGS. 18A to 18E, FIGS. 19A to 19F, FIGS. 20A to 20F, and FIG. 21, image signals are supplied to a plurality of rows of pixels simultaneously, thereby improving the frequency of inputting an image signal to each pixel without being limited by the characteristics of the elements. This facilitates the reduction in color breaks in the field-sequential display device.

Simultaneously letting light of different colors from the backlight unit 701 into different portions of the display region 801 as in the driving method described with reference to FIG. 17, FIGS. 18A to 18E, FIGS. 19A to 19F, FIGS. 20A to 20F, and FIG. 21 is preferable for a field-sequential display device in the following points. In the case where light of one color from the backlight unit 701 is let into the whole display region 801, color information about only a particular color is present on the display region 801 in a particular moment. Therefore, the miss of display information in a particular period due to the user's blinking eyes or the like leads to the miss of particular color information. In contrast, in the case where light of different colors from the backlight unit 701 are simultaneously let into different portions of the display region 801, color information about a plurality of colors is present on the display region 801 in a particular moment. Therefore, the miss of display information in a particular period due to the user's blinking eyes or the like does not lead to the miss of particular color information. In other words, simultaneously letting light of different colors from the backlight unit 701 into different portions of the display region 801 can reduce color break. Further, the driving method described with reference to FIG. 17, FIGS. 18A to 18E, FIGS. 19A to 19F, FIGS. 20A to 20F, and FIG. 21 is one in which light of different colors from the backlight unit 701 are not let into the adjacent blocks in the display region 801, thereby reducing the influence of color mixture. Particularly by increasing the number of the blocks in each of the plurality of regions (the first region 801a, the second region 801b, and the third region 801c) and reducing the number of blocks in which the corresponding transparent layers 103 emit light at the same time, blocks which light of different colors from the backlight unit 701 enter can be placed away from each other. This can further reduce the influence of color mixture.

This embodiment can be freely combined with any of the other embodiments.

### Embodiment 8

This embodiment shows one embodiment of a display panel used in combination with the backlight unit in the above embodiments.

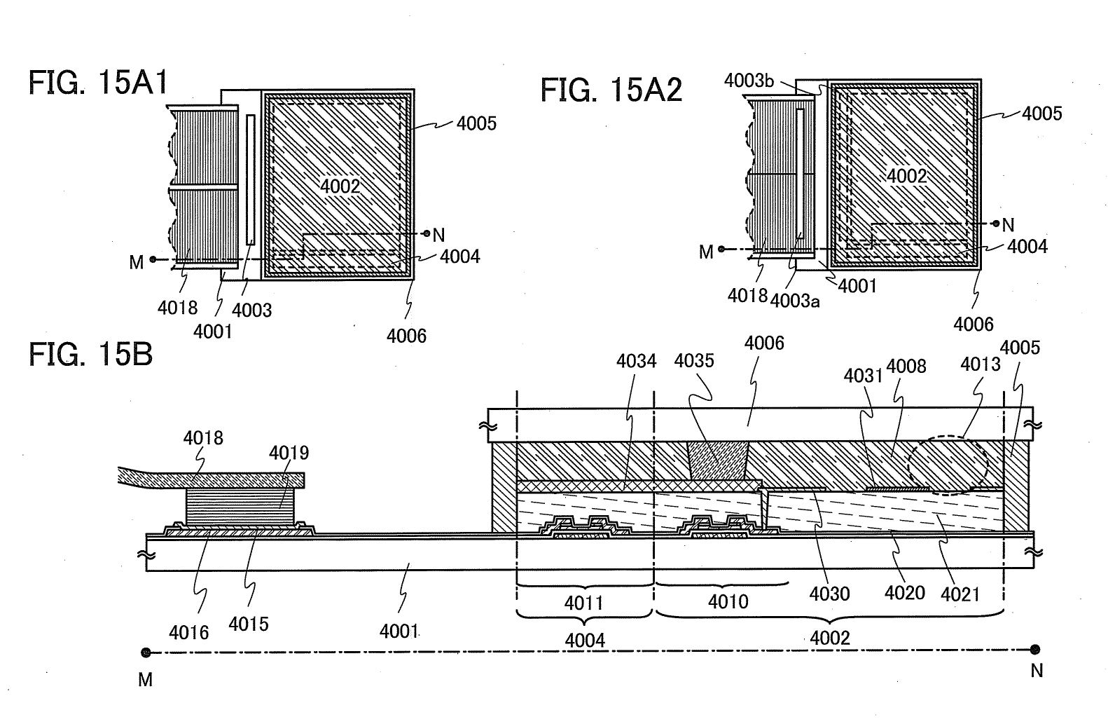

The external view and section of the display panel will be described with reference to FIGS. 15A1, 15A2, and 15B. FIGS. 15A1 and 15A2 are the top views of the display panel. FIG. 15B is a cross-sectional view along M-N in FIGS. 15A1 and 15A2.

A sealant 4005 is provided so as to surround a display region 4002 and scan line driver circuit 4004 provided over a first substrate 4001. In addition, a second substrate 4006 is provided over the display region 4002 and the scan line driver circuit 4004. The display region 4002 and the scan line driver circuit 4004 are sealed together with a liquid crystal layer 4008 by the first substrate 4001, the sealant 4005, and the second substrate 4006. The first substrate 4001 corresponds to the element substrate. As the first substrate 4001 and the second substrate 4006, light-transmitting glass, plastic, or the like can be used.

A columnar spacer 4035 is provided to control the thickness (cell gap) of the liquid crystal layer 4008. The columnar spacer 4035 can be fainted by selective etching of an insulating film. Note that a spherical spacer may be used instead of the columnar spacer 4035.

In FIG. 15A1, a signal line driver circuit 4003 is mounted on a region different from the region surrounded by the sealant 4005 over the first substrate 4001. The signal line driver circuit 4003 is formed over a substrate different from the first substrate 4001 and the second substrate 4006 and formed using a single crystal semiconductor film or polycrystalline semiconductor film. FIG. 15A2 illustrates the case where a part of the signal line driver circuit is formed over the first substrate 4001 with the use of a transistor. A signal line driver circuit 4003b is formed over the first substrate 4001 with the use of a transistor. Further, a signal line driver circuit 4003a is contained on the first substrate 4001. The signal line driver circuit 4003a is formed over a substrate different from the first substrate 4001 and the second substrate 4006 and formed using a single crystal semiconductor film or polycrystalline semiconductor film. Note that the scan line driver circuit may be formed separately to be mounted, or only part of the scan line driver circuit may be formed separately to be mounted.

There is no particular limitation on the method of mounting a driver circuit; a COG method, a wire bonding method, a TAB method, or the like can be used. FIG. 15A1 illustrates the case where the signal line driver circuit 4003 is mounted by the COG method. FIG. 15A2 illustrates the case where the signal line driver circuit 4003 is mounted by the TAB method.

The display region 4002 and scan line driver circuit 4004 provided over the first substrate 4001 include a plurality of transistors. FIG. 15B illustrates the transistor 4010 included in the display region 4002 and the transistor 4011 included in the scan line driver circuit 4004. There is no particular limitation on the kind of the transistors 4010 and 4011; a variety of transistors can be used. A semiconductor such as silicon (e.g., amorphous silicon, microcrystalline silicon, or polysilicon) or an oxide semiconductor can be used for an active layer (a layer in which a channel is formed) in each of the transistors 4010 and 4011.

Since a transistor is easily damaged by static electricity or the like, a protection circuit is preferably provided to a gate line which is electrically connected to the gate of the transistor or to a source line which is electrically connected to the source or the drain of the transistor. The protection circuit is preferably formed using a non-linear element using an oxide semiconductor.

Insulating layers 4020 and 4021 are formed over the transistors 4010 and 4011. Note that one of the insulating layers 4020 and 4021 is not necessarily provided and more insulating layers may be provided over the transistors 4010 and 4011. The insulating layer 4020 serves as a protective film. The insulating layer 4021 serves as a planarization film that reduces unevenness due to the transistors and the like. The protective film is provided to prevent contaminant impurities such as an organic substance, metal, or moisture existing in the air from entering the transistors and is preferably a dense film. The protective film may be a single layer or a stacked layer of a silicon oxide film, a silicon nitride film, a silicon oxynitride film, a silicon nitride oxide film, an aluminum oxide film, an aluminum nitride film, an aluminum oxynitride film, or an aluminum nitride oxide film by sputtering. After the protective film is formed, a semiconductor layer to be the active layers of the transistors 4010 and 4011 may be subjected to heat treatment. The planarization film can be an organic resin film, for example.

The display region 4002 is provided with a liquid crystal element 4013. The liquid crystal element 4013 includes a pixel electrode layer 4030, a common electrode layer 4031, and the liquid crystal layer 4008. The pixel electrode layer 4030 is electrically connected to the transistor 4010. A variety of kinds of liquid crystal can be used for the liquid crystal layer 4008. For example, a liquid crystal layer exhibiting a blue phase can be used. The pixel electrode layer 4030 and the common electrode layer 4031 can be formed using a light-transmitting conductive material such as indium oxide containing tungsten oxide, indium zinc oxide containing tungsten oxide, indium oxide containing titanium oxide, indium tin oxide containing titanium oxide, indium tin oxide (ITO), indium zinc oxide, or indium tin oxide to which silicon oxide is added. A conductive composition containing a conductive high molecule (also referred to as a conductive polymer) can be used for the pixel electrode layer 4030 and the common electrode layer 4031.

FIGS. 15A1, 15A2, and FIG. 15B show the case where an electrode structure used in the in plane switching (IPS) mode is employed. Note that the electrode structure is not limited to the IPS mode; an electrode structure used in the fringe field switching (FFS) mode can be employed instead.

Further, each signal and potential is supplied to the signal line driver circuit, the scan line driver circuit, or the display region 4002 from an FPC 4018. In FIGS. 15A1, 15A2, and FIG. 15B, a connection terminal electrode 4015 is formed using the same conductive film as the pixel electrode layer 4030, and a terminal electrode 4016 is formed using the same conductive film as source and drain electrode layers of the transistors 4010 and 4011. The connection terminal electrode 4015 is electrically connected to a terminal of the FPC 4018 through an anisotropic conductive film 4019.

In FIGS. 15A1, 15A2, and FIG. 15B, a light-blocking layer 4034 is provided on the first substrate 4001 side to cover the transistors 4010 and 4011. The light-blocking layer 4034 can increase the effect of stabilizing the characteristics of the transistors. Since the light-blocking layer 4034 is provided on the first substrate 4001 side, in the case where a liquid crystal layer exhibiting a blue phase is used as the liquid crystal layer 4008, emitting ultraviolet rays from the second substrate 4006 side for polymer stabilization in the liquid crystal allows the liquid crystal layer over the light-blocking layer 4034 to have stabilized blue phases. Note that the light-blocking layer 4034 may be provided over the second substrate 4006.

Note that a color filter is not needed for a field-sequential display device. Furthermore, unlike in the structure in which a light-blocking layer is provided to the substrate (the second substrate 4006) opposed to the element substrate, in the structure like that in FIGS. 15A1, 15A2, and 15B in which the light-blocking layer 4034 is provided on the first substrate 4001 side, it is acceptable that any structure is not provided over a surface of the second substrate 4006. This can simplify the process for fabricating the display device, thereby enhancing yield.

This embodiment can be freely combined with any of the other embodiments.

### Embodiment 9

A display device including the backlight unit disclosed in this specification can be used in a variety of electronic devices (including game machines). Examples of electronic devices include television sets (also referred to as televisions or television receivers), monitors of computers or the like, cameras such as digital cameras or digital video cameras, digital photo frames, cellular phone handsets (also referred to as cellular phones or cellular phone devices), portable game machines, personal digital assistants, audio reproducing devices, and large game machines such as pinball machines. Examples of electronic devices each including the display device described in the above embodiments will be described.

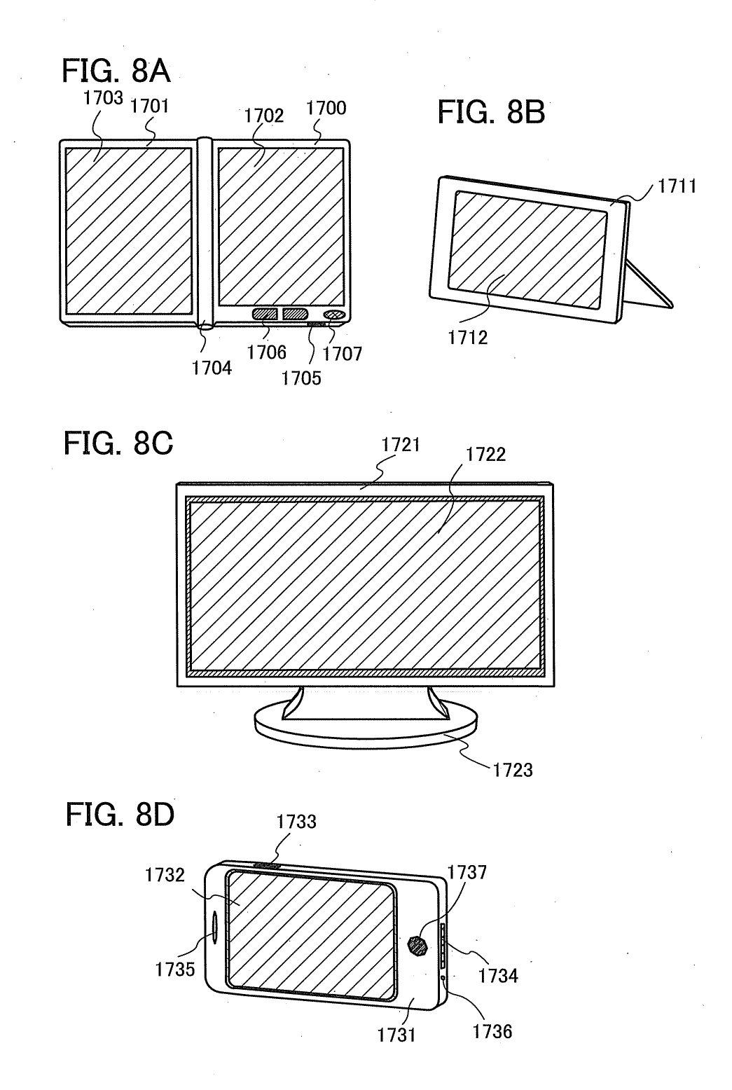

FIG. 8A illustrates an example of an e-book reader using a display device including the backlight unit disclosed in this specification. The e-book reader illustrated in FIG. 8A includes two housings 1700 and 1701. The housings 1700 and 1701 are combined with each other with a hinge 1704 so that the e-book reader can be opened and closed. With such a structure, the e-book reader can operate like a paper book.

A display region 1702 and a display region 1703 are incorporated in the housing 1700 and the housing 1701, respectively. The display region 1702 and the display region 1703 may display one image or different images. In the case where the display region 1702 and the display region 1703 display different images, for example, a display portion on the right side (the display region 1702 in FIG. 8A) can display text and a display portion on the left side (the display region 1703 in FIG. 8A) can display images.

FIG. 8A illustrates an example in which the housing 1700 includes an operation portion and the like. For example, the housing 1700 includes a power input terminal 1705, operation keys 1706, a speaker 1707, and the like. With the operation key 1706, pages can be turned. Note that a keyboard, a pointing device, or the like may be provided on the same surface as the display region of the housing. Further, an external connection terminal (e.g., an earphone terminal, a USB terminal, or a terminal that can be connected to a variety of cables such as USB cables), a recording medium insertion portion, or the like may be provided on a back surface or a side surface of the housing. Further, the e-book reader illustrated in FIG. 8A may function as an electronic dictionary.

FIG. 8B illustrates an example of a digital photo frame including a display device that includes the backlight unit disclosed in this specification. For example, in the digital photo frame illustrated in FIG. 8B, a display region 1712 is incorporated in a housing 1711. The display region 1712 can display a variety of images. For example, the display region 1712 can display data of images taken with a digital camera or the like, so that the digital photo frame can function as a normal photo frame.

Note that the digital photo frame illustrated in FIG. 8B includes an operation portion, an external connection terminal (e.g., a USB terminal or a terminal that can be connected to a variety of cables such as USB cables), a recording medium insertion portion, and the like. Although these components may be provided on the same surface as the display region, it is preferable to provide them on a side surface or a back surface for the design of the digital photo frame. For example, a memory for storing data of images taken with a digital camera is inserted in the recording medium insertion portion of the digital photo frame, so that the image data can be transferred and then displayed on the display region 1712.

FIG. 8C illustrates an example of a television set including a display device that includes the backlight unit disclosed in this specification. In the television set illustrated in FIG. 8C, a display region 1722 is incorporated in a housing 1721. The display region 1722 can display images. Further, the housing 1721 is supported by a stand 1723 here.

The television set illustrated in FIG. 8C can be operated by an operation switch of the housing 1721 or a separate remote control. Channels and volume can be controlled with operation keys of the remote control, so that images displayed on the display region 1722 can be controlled. Further, the remote control may include a display region for displaying data output from the remote control.

FIG. 8D illustrates an example of a cellular phone handset including a display device that includes the backlight unit disclosed in this specification. The cellular phone handset illustrated in FIG. 8D includes a display region 1732 incorporated in a housing 1731, operation buttons 1733 and 1737, an external connection port 1734, a speaker 1735, a microphone 1736, and the like.

The display region 1732 of the cellular phone handset illustrated in FIG. 8D is a touch panel. When the display region 1732 is touched with a finger or the like, contents displayed on the display region 1732 can be controlled. Further, operations such as making calls and composing mails can be performed by touching the display region 1732 with a finger or the like.

This embodiment can be freely combined with any of the other embodiments.

This application is based on Japanese Patent Application serial no. 2010-253456 filed with Japan Patent Office on Nov. 12, 2010, the entire contents of which are hereby incorporated by reference.

What is claimed is:

1. A backlight unit comprising:
a light guide plate comprising:
(j+1) reflective walls (j is a natural number), the (j+1) reflective walls having height in a direction perpendicular to a bottom face, extending in one direction parallel to the bottom face, and being provided in parallel to each other; and
an r-th transparent layer (r is a natural number, 1≦r≦j), the r-th transparent layer being between an r-th reflective wall and an (r+1)-th reflective wall of the (j+1) reflective walls; and
an r-th light source adjacent to a surface of the r-th transparent layer to let light into the r-th transparent layer, the surface being perpendicular to a direction in which the (j+1) reflective walls extend.

2. The backlight unit according to claim 1, wherein the light guide plate comprises a reflective layer provided to the bottom face.

3. The backlight unit according to claim 1, further comprising a reflective mirror surrounding the r-th light source.

4. The backlight unit according to claim 1, further comprising a condenser lens surrounding the r-th light source.

5. The backlight unit according to claim 1, further comprising an optical fiber between the r-th transparent layer and the r-th light source.

6. The backlight unit according to claim 1, wherein the r-th transparent layer comprises a material selected from the group consisting of quartz, glass and plastics.

7. A display device comprising a backlight unit and a display panel irradiated with light from the backlight unit, the backlight unit comprising:
a light guide plate comprising:
(j+1) reflective walls (j is a natural number), the (j+1) reflective walls having height in a direction perpendicular to a bottom face, extending in one direction parallel to the bottom face, and being provided in parallel to each other; and
an r-th transparent layer (r is a natural number, 1≦r≦j), the r-th transparent layer being between an r-th reflective wall and an (r+1)-th reflective wall of the (j+1) reflective walls; and
an r-th light source adjacent to a surface of the r-th transparent layer to let light into the r-th transparent layer, the surface being perpendicular to a direction in which the (j+1) reflective walls extend,
wherein the display panel comprises a display region with pixels arranged in a matrix,
wherein a row direction of the display region is parallel to the direction in which the (j+1) reflective walls extend,
wherein the display region is divided into j regions including at least one row, and
wherein an r-th region is over the r-th transparent layer.

8. A display device according to claim 7, wherein the light guide plate comprises a reflective layer provided to the bottom face.

9. A display device according to claim 7, further comprising a reflective mirror surrounding the r-th light source.

10. A display device according to claim 7, further comprising a condenser lens surrounding the r-th light source.

11. A display device according to claim 7, further comprising an optical fiber between the r-th transparent layer and the r-th light source.

12. The backlight unit according to claim 7, wherein the r-th transparent layer comprises a material selected from the group consisting of quartz, glass and plastics.

13. A display device according to claim 7,
wherein the display region is divided into a plurality of zonal regions including a plurality off regions, and
wherein image signals are simultaneously input to the pixels in any row in each of the zonal regions.

14. A display device according to claim 7,
wherein the display region is irradiated with light emitted from a face of the backlight unit, the face being parallel to the bottom face.

15. A manufacturing method for a backlight unit, comprising the steps of:
forming a transparent layer over a bottom face;
forming a plurality of grooves in the transparent layer, the plurality of grooves having height in a direction perpendicular to the bottom face, extending in one direction parallel to the bottom face, and being in parallel to each other;
forming a plurality of reflective walls in the plurality of grooves; and
forming a plurality of light sources adjacent to a surface of the transparent layer, wherein the surface is perpendicular to a direction in which the plurality of grooves extend.

16. The manufacturing method according to claim 15, further comprising the step of:
forming a reflective layer over the transparent layer and the plurality of reflective walls.

17. The manufacturing method according to claim 15, wherein the bottom face is a face of a reflective layer.

18. The backlight unit according to claim 15, comprising a reflective mirror surrounding the light source.

19. The backlight unit according to claim 15, comprising a condenser lens surrounding the light source.

20. The backlight unit according to claim 15, comprising an optical fiber between the transparent layer and the light source.

21. The backlight unit according to claim 15, wherein the transparent layer comprises a material selected from the group consisting of quartz, glass and plastics.
